(19) United States
(12) Patent Application Publication
(10) Pub. No.: US 2025/0001512 A1
(43) Pub. Date: Jan. 2, 2025

(54) Systems for Dual Plasma Wire Arc Additive Manufacturing and Methods Thereof

(71) Applicant: Relativity Space, Inc., Long Beach, CA (US)

(72) Inventors: Jenna Johns, Long Beach, CA (US); Fritz Gruber, Redondo Beach, CA (US); Jeremy Krol, Long Beach, CA (US); Michael Reid, Long Beach, CA (US)

(73) Assignee: Relativity Space, Inc., Long Beach, CA (US)

(21) Appl. No.: 18/757,320

(22) Filed: Jun. 27, 2024

Related U.S. Application Data
(60) Provisional application No. 63/510,846, filed on Jun. 28, 2023.
(60) Provisional application No. 63/593,926, filed on Oct. 27, 2023.

(51) Int. Cl. B23K 9/013; B23K 9/04; B23K 9/167; B23K 10/00; B33Y 10/00; B33Y 40/20

(52) U.S. Cl. CPC B23K 9/013; B23K 9/042; B23K 9/167; B23K 10/003; B33Y 10/00; B33Y 40/20

(57) ABSTRACT

A plasma arc torch assembly is capable of additively manufacturing articles. A device may additively manufacture at least a portion of an article using the plasma arc torch assembly. A device may deactivate at least one plasma arc associated with the plasma arc torch assembly. A device may perform plasma arc surface smoothing of the article using the plasma arc torch assembly.

### CROSS-REFERENCE TO RELATED APPLICATIONS

The current disclosure claims the benefit, under 35 U.S.C. § 119 (e), of U.S. Provisional Patent Application No. 63/510,846 entitled “Plasma Arc Surface Smoothing” filed Jun. 28, 2023, and U.S. Provisional Patent Application No. 63/593,926 entitled “Dual Plasma Wire Arc Additive Manufacturing” filed Oct. 27, 2023. The disclosures of U.S. Provisional Patent Application No. 63/510,846 and U.S. Provisional Patent Application No. 63/593,926 are hereby incorporated by reference in their entirety for all purposes.

### FIELD OF THE INVENTION

The present invention generally relates to robotic wire arc additive manufacturing (WAAM) systems.

### BACKGROUND

Additive manufacturing is a process by which a product or part is manufactured by adding one layer of material on top of another in a sequence or pattern to build a solid part. This method of manufacturing is commonly referred to as three dimensional or 3D printing and can be done with different materials, including plastic and metal. Wire arc additive manufacturing is a production process used to 3D print and/or repair metal parts using a wire arc. Although wire arc additive manufacturing uses some terms that are also used in metal inert gas (MIG) welding, they can be different processes. MIG welding is an arc welding process that uses a continuous solid wire electrode heated and fed into the weld pool from a welding gun in a process for joining two pieces of metal together. Wire arc additive manufacturing is not strictly a joining process and, instead, builds a structure by successively adding layers of metal from a melted and solidified wire.

3D printing of metallic structures typically involves using an energy source to create a weld pool and feeding a metal wire (feed material) into the weld pool by way of a printing head or printing head nozzle.

The process by which material is deposited can be controlled by the use of shielding gas around the feeding material. The shielding gas can help to make a better weld pool for an overall better part. The shielding gas can protect the weld pool from corrosive gases and moisture.

Ordinarily, after an article is manufactured, it can be necessary to perform surface finishing steps, such as wire brushing, laser cleaning, and machining. Surface finishing steps can remove parasitic mass and/or otherwise improve the manufactured article.

### SUMMARY OF THE INVENTION

Systems and methods in accordance with many embodiments of the invention are directed to dual plasma systems and dual plasma wire arc additive manufacturing (WAAM) processes. Some embodiments apply surface finish to articles manufactured using WAAM and/or related processes.

Some embodiments include a method for smoothing a surface of an additively manufactured article, the method comprising:
printing, using an additive print head, a first layer of an additively manufactured article;
printing, using the additive print head, a second layer of the additively manufactured article, wherein the second layer is adjacent to the first layer, and wherein an edge of the first layer and an edge of the second layer define a surface of the additively manufactured article; and
smoothing, using the additive print head, the surface of the additively manufactured article after printing the first layer and printing the second layer.

In some embodiments, the printing the first layer includes directing, via the additive print head, a feed wire toward the first layer and further includes applying, via the additive print head, electrical energy through the feed wire to the additively manufactured article.

In some embodiments, the printing the first layer includes directing, via the additive print head, a feed wire toward the first layer and further includes applying, via the additive print head, electrical energy through an electrode separate from the feed wire to the additively manufactured article.

In some embodiments, the smoothing the surface includes applying, via the additive print head, electrical energy through an electrode separate from a feed wire to the additively manufactured article.

In some embodiments, the smoothing the surface includes applying, via the additive print head, electrical energy through an electrode separate from the feed wire to the additively manufactured article.

In some embodiments, the smoothing the surface includes applying, via the additive print head, electrical energy through an electrode separate from the feed wire to the additively manufactured article.

In some embodiments, the printing the first layer includes directing, via the additive print head, a feed wire toward the first layer and further includes applying an electrical arc to melt the feed wire to form the first layer of the additively manufactured article.

In some embodiments, the printing the first layer includes directing, via the additive print head, a feed wire toward the first layer and further includes applying, via the additive print head, electrical energy through an electrode separate from the feed wire to a gas to form a plasma arc to shield the additively manufactured article.

In some embodiments, the smoothing the surface includes applying, via the additive print head, electrical energy through an electrode separate from a feed wire to a gas to form a plasma arc; wherein the plasma arc smooths the surface of the additively manufactured article.

In some embodiments, the smoothing the surface includes applying, via the additive print head, electrical energy through an electrode separate from the feed wire to a gas to form a plasma arc; wherein the plasma arc smooths the surface of the additively manufactured article.

In some embodiments, the smoothing the surface includes applying, via the additive print head, electrical energy through an electrode separate from the feed wire to a gas to form a plasma arc; wherein the plasma arc smooths the surface of the additively manufactured article.

In some embodiments, the printing the first layer includes using a MIG component of the additive print head.

In some embodiments, the printing the first layer includes using a TIG component of the additive print head.

In some embodiments, the smoothing the surface includes using a TIG component of the additive print head.

In some embodiments, the smoothing the surface includes using a TIG component of the additive print head.

In some embodiments, the smoothing the surface includes using a TIG component of the additive print head.

In some embodiments, the additive print head includes at least one exit for surface smoothing plasma, and wherein smoothing the surface includes directing, via the additive print head, the surface smoothing plasma toward the surface of the additively manufactured article.

In some embodiments, the smoothing the surface includes moving the additive print head above the first layer and the second layer in a weave pattern.

In some embodiments, the smoothing the surface reduces a parasitic mass of the additively manufactured article.

In some embodiments, the additive print head comprises a dual plasma torch.

Some embodiments include a system for smoothing a surface of an additively manufactured article, the system comprising:
at least one processing unit; and
at least one memory coupled to the at least one processing unit and storing instructions for execution by the at least one processing unit, the instructions when executed by the at least one processing unit cause the system to perform acts comprising:
printing, using an additive print head, a first layer of an additively manufactured article;
printing, using the additive print head, a second layer of the additively manufactured article, wherein the second layer is adjacent to the first layer, and wherein an edge of the first layer and an edge of the second layer define a surface of the additively manufactured article; and
smoothing, using the additive print head, the surface of the additively manufactured article after printing the first layer and printing the second layer.

Some embodiments include a system for smoothing a surface of an additively manufactured article, the system comprising:
an additive print head;
at least one processing unit; and
at least one memory coupled to the at least one processing unit and storing instructions for execution by the at least one processing unit, the instructions when executed by the at least one processing unit cause the system to perform acts comprising:
printing, using the additive print head, a first layer of an additively manufactured article;
printing, using the additive print head, a second layer of the additively manufactured article, wherein the second layer is adjacent to the first layer, and wherein an edge of the first layer and an edge of the second layer define a surface of the additively manufactured article; and
smoothing, using the additive print head, the surface of the additively manufactured article after printing the first layer and printing the second layer.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure

### BRIEF DESCRIPTION OF THE DRAWINGS

The description and claims will be more fully understood with reference to the following figures and data graphs, which are presented as example embodiments of the invention and should not be construed as a complete recitation of the scope of the invention.

FIG. 1 is a schematic of a deposition system including a print head using two feed wires to deposit material into a weld pool in accordance with an embodiment of the invention.

FIG. 2 is a schematic of a deposition system including the print head of FIG. 1 with two wire feeders being moved to thereby move the weld pool in accordance with an embodiment of the invention.

FIG. 3A schematically illustrates a top-down view of the deposition system of FIGS. 1 and 2 in accordance with an embodiment of the invention.

FIG. 3B illustrates a magnified schematic of the deposition system of FIG. 2.

FIG. 4A illustrates schematically illustrates a top-down view of the deposition system in accordance with an embodiment of the invention.

FIG. 4B illustrates a magnified schematic of a deposition system in accordance with an embodiment of the invention.

FIG. 5 is a schematic of a deposition system illustrating the workpiece being moved relative to an electrode wire feeder to thereby move a weld pool, while a second wire feeder deposits additional material into the weld pool in accordance with an embodiment of the invention.

FIG. 6 is a schematic of a multi-wire deposition system in accordance with an embodiment of the invention.

FIG. 7 is a diagram that illustrates equations that model a relationship between a Q value and other parameters of a two-wire deposition process.

FIG. 8 is a high-level diagram illustrating a second feed rate estimator that determines a feed rate for the second wire.

FIG. 9 is a high-level diagram that illustrates using a defect detector to optimize input electric power.

FIG. 10 is a high-level diagram that illustrates using edge sensors to optimize input electric power and other process parameters.

FIG. 11 is a high-level diagram that illustrates using an alloy schedule to deposit different alloys at different locations in a structure.

FIG. 12 schematically illustrates different positionings of the print head with respect to the workpiece to demonstrate the effects of gravity on the melt pool.

FIG. 13A illustrates a schematic of a system for printing with a print head in accordance with an embodiment of the invention.

FIG. 13B illustrates a schematic perspective view of the workpiece during building with the system of FIG. 13A.

FIG. 14 is a perspective view of a schematic of an example horizontal print system.

FIG. 15 is a flow chart of a method for depositing material using multiple feed wires in accordance with an embodiment of the invention.

FIGS. 16A through 16H conceptually illustrate an example dual plasma torch assembly in accordance with an embodiment of the invention.

FIG. 17 conceptually illustrates a process for additive manufacturing using a dual plasma torch in accordance with an embodiment of the invention.

FIGS. 18A through 18B conceptually illustrate a user interface for controlling a dual plasma additive manufacturing process in accordance with an embodiment of the invention.

FIGS. 19A through 19B show the grain structures of a printed part using a dual plasma additive manufacturing process in accordance with an embodiment of the invention.

FIGS. 20A through 20B show the grain structures of a printed part using a dual plasma additive manufacturing process in accordance with an embodiment of the invention.

FIG. 21 depicts example sample data obtained based on testing samples manufactured using a dual plasma WAAM process in accordance with an embodiment of the invention.

FIGS. 22A through 22B depict samples manufactured using a dual plasma WAAM process in accordance with an embodiment of the invention.

FIG. 23 conceptually illustrates a robotic WAAM manufacturing system in accordance with an embodiment of the invention.

FIG. 24 depicts a robotic WAAM manufacturing system incorporating a dual plasma torch in accordance with an embodiment of the invention.

FIGS. 25A through 25F conceptually illustrate an outer body for a dual plasma torch with cold-wire ports in accordance with an embodiment of the invention.

FIG. 26 conceptually illustrates a dual plasma nozzle component configured to feed up to twelve cold wires through cold wire ports in accordance with an embodiment of the invention.

FIG. 27A through 27C conceptually illustrate a dual plasma multi-wire WAAM manufacturing system in accordance with an embodiment of the invention.

FIG. 28 conceptually illustrates a robotic WAAM manufacturing system in accordance with an embodiment of the invention.

FIG. 29 conceptually illustrates a process for multi-wire additive manufacturing using a dual plasma torch in accordance with an embodiment of the invention.

FIG. 30 conceptually illustrates a cross-section of material added using a dual plasma multi-wire additive manufacturing process in accordance with an embodiment of the invention.

FIG. 31 conceptually illustrates a process for additive manufacturing using a dual plasma torch in accordance with an embodiment of the invention.

FIG. 32 illustrates a surface of an article that has been treated using plasma arc surface smoothing in accordance with an embodiment of the invention.

FIG. 33 illustrates a closeup of a treatment area of an article that has been treated using plasma arc surface smoothing in accordance with an embodiment of the invention.

FIG. 34 illustrates a surface of an article that has been treated using plasma arc surface smoothing in accordance with an embodiment of the invention.

FIG. 35 illustrates a schematic of a weave pattern that can be used during plasma arc surface smoothing to define the path of a plasma arc assembly in accordance with an embodiment of the invention.

FIG. 36 conceptually illustrates a plasma torch system with a torch controller, a MIG torch and a TIG torch in accordance with an embodiment of the invention.

FIG. 37 conceptually illustrates a dual plasma torch system in operation in accordance with an embodiment of the invention.

### DETAILED DESCRIPTION

It will be understood that the components of the embodiments as generally described herein and illustrated in the drawings may be arranged and designed in different configurations. Thus, the following description of various embodiments, as represented in the drawings, is not intended to limit the scope of the disclosure but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive.

Reference throughout this specification to features, advantages, or similar language does not imply that a feature or advantage that may be only realized with a single embodiment of the present invention. These features and/or advantages may be or are in another embodiment of the invention.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment. Thus, the phrases “in one embodiment”, “in an embodiment”, and similar language throughout this specification may, but do not necessarily, all refer to the same embodiment.

### Multi-Wire Printing

3D metal printers have been produced for printing large 3D structures. An example implementation uses wire-arc additive manufacturing (WAAM). Other example implementations of “additive layer manufacturing” using large 3D metal printers are described in U.S. patent application Ser. No. 18/146,292, filed Dec. 23, 2022, and U.S. Patent Application Publication No. 2024/0017340, published Jan. 18, 2024, which are incorporated in this disclosure by reference. The applicant has demonstrated that such large 3D metal printers can print structures 2.75 m (9 ft) or more in diameter and 4.5 m (15 ft) or more in length. With such large 3D metal printers, the printing process involves moving a weld pool along a path while feeding material into the weld pool. The print envelope of such large 3D metal printers greatly exceeds the print envelope of other printing processes such as direct metal laser sintering (DMLS), also called laser powder bed fusion (LPBF), which are 3D metal printers that typically have a print envelope less than or equal to 600 mm diameter by 950 mm in length. With such large 3D metal printers, it is desirable to print the structures quickly such that more structures can be printed within a time period, thereby improving the return on investment on building the printers, printing facilities, etc. A structure may include a known amount of material. The material may include various materials such as aluminum (e.g. aluminum alloys) or nickel (e.g. Inconel).

An example composition may include from about 0.23 to about 0.37 wt % Sc; from about 0.11 to about 0.19 wt % Zr; from about 4.1 to about 5.6 wt % Mg; from about 0.1 to about 1.0 wt % Mn; and less than or equal to about 0.1 wt % of each of Si, Fe, Cu, Ti, Be, Cd, Hg, Ag, B, Be, Zn, Li, and/or lanthanide group elements based on the total weight of the composition; with the balance of the composition being Al. In some embodiments, after T5 heat treatment, and in the absence of a homogenization heat treatment, the composition has a yield strength of greater than or equal to about 240 MPa (35k PSI) when determined according to ASTM E8 or an equivalent thereof on a workpiece comprising the composition having a thickness 0.05″≤ x≤0.375″.

The composition may include less than or equal to about 0.2 wt % Cr, based on the total weight of the composition. In some embodiments, the composition includes less than or equal to about 0.002 wt % B. In some embodiments, the composition further includes less than or equal to about 0.0005 wt % Be. In some embodiments, a ratio of Zr to Sc is less than or equal to about 0.63, less than or equal to about 0.51, less than or equal to about 0.47, or less than or equal to about 0.41, and greater than or equal to about 0.33, or greater than or equal to about 0.38, when determined according to the formula: [Zr wt %/Sc wt %]. In some embodiments, a ratio of Cu to Cr is less than or equal to about 0.41, less than or equal to about 0.33, or less than or equal to about 0.27, and greater than or equal to about 0.05, or greater than or equal to about 0.12, when determined according to the formula [Cu wt %/Cr wt %].

The total composition may include from about 0.1 wt % to 1.0 wt % Mn. In some embodiments, the composition includes greater than or equal to about 0.15 wt % Mn, greater than or equal to about 0.20 wt % Mn, greater than or equal to about 0.25 wt % Mn, or greater than or equal to about 0.3 wt % Mn, greater than or equal to about 0.35 wt % Mn, greater than or equal to about 0.40 wt % Mn, greater than or equal to about 0.45 wt % Mn, greater than or equal to about 0.50 wt % Mn, greater than or equal to about 0.60 wt % Mn, greater than or equal to about 0.65 wt % Mn, greater than or equal to about 0.70 wt % Mn, greater than or equal to about 0.75 wt % Mn, greater than or equal to about 0.80 wt % Mn, greater than or equal to about 0.85 wt % Mn, or greater than or equal to about 0.90 wt % Mn, and less than or equal to about 1 wt %, or less than or equal to about 0.95 wt % Mn.

In some embodiments, the composition includes from about 0.13 wt % Mn to about 0.48 wt % Mn. In some embodiments, the composition includes from about 0.22 wt % Mn to about 0.42 wt % Mn. In some embodiments, the composition includes from about 0.53 Wt % Mn to about 0.82 wt % Mn. In some embodiments, the composition comprises from about 0.64 Wt % Mn to about 0.77 wt % Mn.

The total composition may include from about 0.23 wt % to 37 wt % Sc. In some embodiments, the composition includes from about 0.25 wt % Sc to about 0.36 wt % Sc. In some embodiments, the composition includes from about 0.27 wt % Sc to about 0.35 wt % Sc. In some embodiments, the composition includes from about 0.30 wt % Sc to about 0.34 wt % Sc, based on the total amount of the composition.

In some embodiments, the composition includes less than or equal to about 0.0005 wt % Be based on the total amount of the composition. In some embodiments, the composition includes less than or equal to about 0.0003 wt % Be, or less than or equal to about 0.0003 wt % Be, and greater than or equal to about 0.0001 wt % Be, based on the total amount of the composition.

In some embodiments, the composition further includes less than or equal to about 0.05 wt % Si, based on the total amount of the composition present. In some embodiments, the composition further includes an amount of one or more of Y, Nb, V, Ag, Ti, or a combination thereof, wherein a total amount of these elements is less than or equal to about 0.5 wt %, based on the total amount of the composition present.

In some embodiments, a ratio of the combination of Zr and Ti present to Sc is less than or equal to about 0.3, when determined according to the formula [(Zr wt %+Ti wt %)/Sc wt %].

In some embodiments, the composition is formed into and/or is physically present as a wire, e.g., a welding wire suitable for use in additive manufacturing, having an average diameter of less than or equal to about 2 mm. In some embodiments, the wire formed from the composition has a spooling cast from about 25 to 50 cm, and/or a spooling helix of less than or equal to 0.1 of the spooling cast, when determined according to AWS A5.10, or an equivalent thereof.

In some embodiments, after the T5 heat treatment, the composition has a degree of sensitization (DOS) mass loss of less than or equal to about 15 mg/cm2, when determined according to ASTM G67, or an equivalent thereof.

In some embodiments, a maximum temperature of the T5 heat treatment utilized to produce an article including the composition is less than or equal to about 335° C. (635° F.). A maximum time of the T5 heat treatment may be greater than or equal to about 10 minutes and less than or equal to about 24 hours. In some embodiments, a spooled wire includes the composition of one or more of the compositions disclosed herein.

More specific examples of compositions are disclosed in U.S. Patent Application Publication No. 2023/0313345 published Oct. 5, 2023, and U.S. Patent Application Publication No. 2024/0026497 published Jan. 25, 2024, which are both incorporated by reference in their entirety for all purposes.

In one example, a structure may include 1000 kilograms of aluminum. The feed rate, WFSelectrode, is the rate at which wire is fed into the weld pool. For example, the feed rate can be 1 cm/sec. The wire has a cross-section area. For example, an aluminum wire with a square cross-section that is 0.1 cm per side has a 0.01 cm2 cross-section. Feeding such a wire into the weld pool at 1 cm/see deposits 0.1 cm3 of aluminum per second. The density of aluminum, paluminum, is 2.71 g/cm3. Note that this is the density of pure aluminum, and that alloys and other metals will have different densities. The example process is therefore depositing aluminum at a rate of 0.271 g/sec. It will take 1025 hours to print the 1000 kg structure.

The feed wire carrying electrical energy into the weld pool is the electrode wire (also characterized in this disclosure as a hot wire). The deposition rate can be increased by increasing the feed rate of the electrode wire but increasing that feed rate has a side effect of increasing the input electrical current. In welding, this is known as burn-off. The input current, I (capital letter i), is therefore a function of the electrode wire feed rate (WFSelectrode). The relationship between the input current and the feed rate is called the wire's burn-off characteristic. Those practiced in welding using feed wires are familiar with burn-off and the burn-off characteristic of electrode wires. The result is that the physics of the welding process limit the electrode wire feed rate because high currents can result in welding defects and other problems.

Various embodiments of the disclosure include additional feed wires, which can be used to deposit additional material into the weld pool. In these instances, the total deposition rate is the rate at which material is deposited using all of the feed wires. The inventors discovered that one or more additional feed wires can be used. In this regard, at least a second feed wire can be fed into the weld pool. The second feed wire may be utilized as a “cold” wire. As used herein, a cold wire refers to a feed wire that does not carry electrical energy into the weld pool or carries less electrical energy than the “hot” wire, which is the electrode wire or primary feed wire carrying electrical energy into the weld pool. A cold wire can be pre-heated, e.g., using a charge, before it is deposited and still meet the definition of cold wire. In this regard, use of a current with a cold wire can preheat the wire and allow for easier melt-off; yet, although the current suffices to provide heat, the current does not result in an arc. Use of a cold wire in conjunction with a hot wire increases the mass of metal deposited into the weld pool. Cold wires are described in U.S. Patent Application Publication No. 2023/0173601, published Jun. 8, 2023, and U.S. patent application Ser. No. 18/451,688 filed Aug. 17, 2023, the entire contents of both of which are incorporated by reference in this disclosure. Having no charge (no preheating) may be beneficial for the aluminum-based wires described in the incorporated references above. Preheating may have benefits for other wires, such as Inconel or steel.

In some embodiments, the electrical energy carried by the hot wire or electrode wire (described above) is sufficient to melt the cold wire (the second feed wire) without providing electrical energy to the cold wire. In some embodiments, the second feed wire can be compositionally and structurally identical to the electrode wire. In some embodiments, the second feed wire may be compositionally and/or structurally different from the electrode wire. For example, the second feed wire can be of a different material than the electrode wire and/or have a different diameter than the electrode wire. In some embodiments, the second feed wire can be fed into the weld pool at the same rate as the electrode wire, which results in double the printing rate and thus the printing time may be cut in half. Other rates are within the scope of the invention, however.

In 3D printing, a toolpath file can be used to specify the actions that printing components are to take, the order in which the actions are to be taken, and when each action is to be taken. For example, a first action can be to move the print head along a specified path at a specified travel speed. At the same time, wire feeders can feed wires at specified rates and the electrode current and voltage produced by an electric power source can be set. Another action can be taken when the print head completes its movement along the first path such that the print head moves along a different specified path at the same or a different specified travel speed. Changes in the feed rates and input electric power can be set to occur at various locations along the specified travel paths. Those familiar with 3D printing are familiar with the creation of and contents of toolpath files. Common toolpath file formats include (but are not limited to) GCODE, X3G, etc.

### Dual Plasma Wire Arc Additive Manufacturing

3-D printing of metallic structures typically involves using an energy source to create a weld pool and feeding a metal wire feed material into the weld pool by way of a printing head or printing head nozzle. Energy is used to create the weld pool. Wire Arc Additive Manufacturing (WAAM) systems typically pass an electric current through the feed wire into the weld pool. The printing head, and subsequently the weld pool can be moved. As the printing head and the welding pool moves, the trailing edge of the pool cools and solidifies. Through this process of gradually moving the printing head along a path can lead to a fully printed part.

The process by which material is deposited can be controlled by the use of shielding gas around the feed material. The shielding gas can help to make a better weld pool for an overall better part. The shielding gas can protect the weld pool from corrosive gases and moisture.

In several embodiments, an additive manufacturing applicator (e.g., a torch) can be configured to achieve improvements to deposition rates and/or quality in WAAM processes. In this specification, the applicator is sometimes referred to specifically as a dual plasma torch and/or an assisted plasma torch. As discussed in greater detail below, embodiments of the dual plasma torch and its associated dual plasma processes combine MIG welding (e.g., high melt-off MIG welding) and plasma welding (e.g., high quality plasma or tungsten inert gas (TIG) welding).

The applicator can have a central channel where the feedstock (such as feed wires; or wires) can be fed through. The feedstock can be melted by an arc (such as an electric arc) at a distal end of the central channel. The melted feedstock can be deposited on a substrate in a layer-by-layer fashion such that a workpiece (or a part) can be formed using the feedstock. A voltage is applied between the feedstock and the substrate such that the arc can be generated to melt the feedstock. In various embodiments, a pilot arc forms between a second electrode different from the feed wire (such as a tungsten electrode) and the applicator's nozzle; and an additional arc (e.g., an ionizing arc capable of generating an assisting plasma) is grounded to the workpiece. The assisting plasma can provide additional shielding to the feedstock and/or the workpiece during printing. Using an assisted plasma torch as a wire arc additive manufacturing applicator can be advantageous to improve output quality (e.g., grain structure), and to improve deposition rates. The inventors believe that improved grain structure results because the temperature distribution across the deposition site can be more even as compared to WAAM systems without the assisting plasma.

In accordance with embodiments of the invention, the assisting plasma can be located between the feed wire and the shielding gas. The assisting plasma can be issued from an assisting plasma channel. Assisting plasma channels can have circular exits that are concentric with feed wires. The feed wire can be concentric with an exit of a shielding gas. The inside of the assisting plasma channel can be formed of two electrically isolated surfaces. An electrode side of the channel can be electrically connected with an electrode. An outer body side of the channel can be the opposite side from the electrode side. The outer body side can have an insulating coating on a first portion of the channel located distal relative to the electrode. The outer body side can have an uninsulated second portion of the channel located proximal relative to the electrode.

In various embodiments, the assisting plasma can be directed through a circular exit. The circular exit can have an insert. The insert can be formed of ceramic. The insert can have a central through-hole. The insert can be a threaded part for easy removal and/or replacement. The insert can be made of a material that is non-wetting with the liquid (e.g., melted) form of the feed wire. The insert can be made of ceramic materials such as (but not limited to) alumina, boron nitride, glass, borosilicate, soda lime glass, a dielectric polymer, a fluorinated polymer, polytetrafluoroethylene. This can make the system suitable for a large diameter feed wire (e.g., about 2 mm, about 2.4 mm, or diameter greater than about 2 mm). A large diameter wire feed can be greater than would be suitable for a similar system without a dual plasma aspect. The feed wire can, in various embodiments, pass through the insert. The assisting plasma can be used in a dual plasma wire arc additive manufacturing process. The insert can, in various embodiments, protrude further towards a deposition site than the shielding gas channel exit. In several embodiments, the insert can be the closest part (e.g., not considering the feed wire) of the nozzle to the workpiece and/or deposition site.

### Dual Plasma Multi-Wire Wire Arc Additive Manufacturing

Combining multi-wire (e.g., a hot wire and one or more cold wires, as the term is defined above) feeding processes with dual plasma WAAM processes can beneficially improve WAAM deposition rates. In accordance with many embodiments, one or more cold wires can be advanced into a weld pool generated by a dual plasma WAAM process. The cold wires can be in addition to the electrode wire (e.g., hot wire). In several embodiments, cold wires can be run at a feed rate less than the feed rate used for the hot wire in dual-plasma multi-wire process. For example, cold wires can be run at about 50% feed rate compared to feed rate of a hot wire. In some embodiments, cold wires can be run at less than about 50% feed rate compared to feed rate of a hot wire. In certain embodiments, cold wires can be run at greater than about 50% feed rate compared to feed rate of a hot wire. Dual plasma multi-wire processes can, in accordance with embodiments, achieve deposition rates of around 25 pounds per hour. In several embodiments, dual plasma multi-wire processes can achieve deposition rates of greater than about 25 pounds per hour. This deposition rate can be achieved with aluminum alloy wires in accordance with embodiments of the invention. In several embodiments, deposition rates can increase with the inclusion of additional cold wires. For example, in many embodiments, advancing 3 cold wires into a weld pool during a WAAM process can permit achievement of a deposition rate of at least around 30 pounds per hour. For comparison, various legacy systems can have deposition rates of around 3.9 pounds per hour to around 6.3 pounds per hour. This solution improves the deposition rate without significant degradation of defect levels.

### Multi-Wire Wire Arc Additive Manufacturing

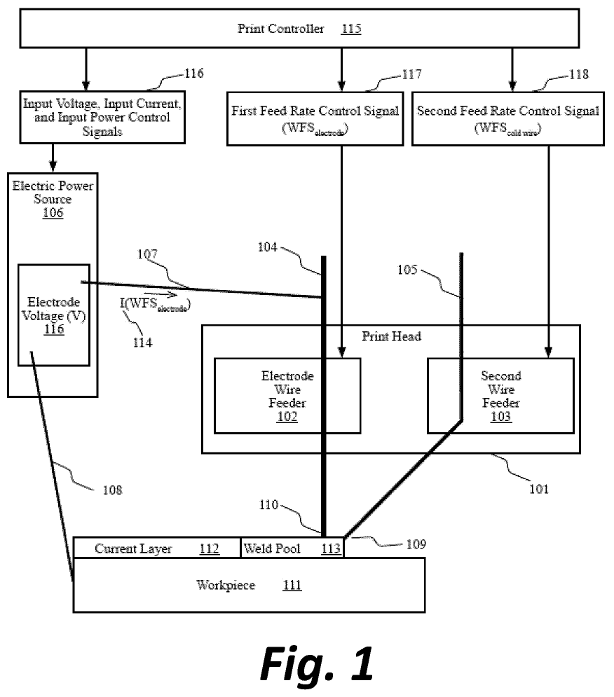

FIG. 1 is a schematic of a deposition system including a print head 101 using two feed wires to deposit materials into a weld pool in accordance with an embodiment of the invention. The print controller 115 can interpret a toolpath file and can control various components of a 3D printer in accordance with the toolpath file. Based on the toolpath file, the print controller 115 can output certain control signals at certain times or points in the print. The control signals may be analog signals and/or digital signals. Signals (e.g., control signals) may indicate or encode values (e.g., control values). The print controller 115 can send control signals to other components that can receive those control signals. An electric power source may receive control signals such as an input voltage signal, an input current signal, an input power control signal, etc. from the print controller 115. Based on the control values from the print controller 115, the electric power source 106 can produce an electrode voltage 116 and an electrode current, I(WFSelectrode). The electrode current 114 can pass through an electrode cable 107 to the electrode wire 104. The electrode current 114 may be manipulated through the electrode wire feed rate (WFSelectrode).

A print head 101 can include an electrode wire feeder 102 and a second wire feeder 103. The print head 101 may receive control signals such as a first feed rate control signal 117 and a second feed rate control signal 118 from the print controller 115. Based on the control values from the print controller 115, the electrode wire feeder 102 may feed an electrode wire 104 at the first feed rate WFSelectrode. The electrode current 114 can pass from the electric power source 106, through the electrode cable 107, through the electrode wire 104, into the workpiece 111, through the work cable 108, and back to the electric power source 106. In some embodiments, the electric current flows in a direction opposite of that indicated in FIG. 1. The electrode wire thereby delivers input electric power to the electrode end 110 where the electrode wire 104 melts into a weld pool 113. The weld pool is a volume of molten metal on the workpiece 111. Moving the workpiece 111 relative to the print head 101 moves the electrode end 110 and thereby moves the weld pool 113 relative to the workpiece 111. As the weld pool moves, an amount of cooling metal remains behind and solidifies. The workpiece can be built up layer by layer. The current layer 112 is the layer currently being deposited on the workpiece 111.

As discussed above, a second feed wire 105 may be utilized to increase the deposition rate onto the workpiece 111. Examples of systems and methods for two wire deposition are described in U.S. Patent Application Publication No. 2023/0173601 published Jun. 8, 2023, incorporated by reference above.

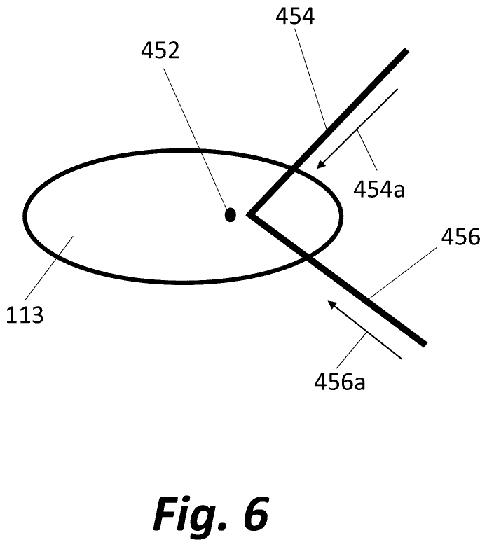

In some embodiments, more wires such as a third and/or fourth feed wire, in addition to the second feed wire 105, can also be utilized to increase further the deposition rate onto the workpiece 111. The third and/or fourth feed wire may not have a voltage applied to it/them or may have a lower voltage than the electrode wire 104 applied to it/them, similar to the second feed wire 105. In embodiments incorporating a third and/or fourth feed wire, the voltage applied to each wire does not need to be the same. For example, a voltage can be applied to the second feed wire 105 but not to the third feed wire or a different voltage can be applied to the third feed wire than to the second feed wire 105; likewise, if utilized, no voltage may be applied to the fourth feed wire or a different voltage can be applied to the fourth feed wire than the second feed wire 105 and/or third feed wire. Examples of different configurations which include a third and/or fourth feed wire are described in connection with FIGS. 6A and 6B.

Based on the control values (e.g., second feed rate control signal 118) from the print controller 115, the second wire feeder 103 may feed the second wire 105 at the second feed rate WFScold wire. The second wire end 109 is also fed into the weld pool 113 where it melts. The second wire end 109 is melted by the heat energy in the weld pool. That heat energy is produced by the electrode current 114. In the illustrated embodiment, the second wire 105 carries no electric current that adds energy to the weld pool. In some embodiments, an electric current may be present in the second wire 105. In some embodiments, the electric current may be used to preheat the second wire 105. In some embodiments, shield gas may be utilized while the deposition takes place. The shield gas may be an inert gas (e.g. helium or argon). Additional examples of systems and methods for shielding gas are described in U.S. Provisional Application No. 63/488,362 filed Mar. 3, 2023, which is hereby incorporated by reference in its entirety for all purposes. In some embodiments, a nozzle may be used which accommodates the electrode wire 104 and maintains a flow of shield gas around the weld pool 113. The shield gas may be used to prevent unwanted oxidation reactions during the deposition. However, as will be discussed below, the introduction of the second wire 105 may create shadows for the shield gas.

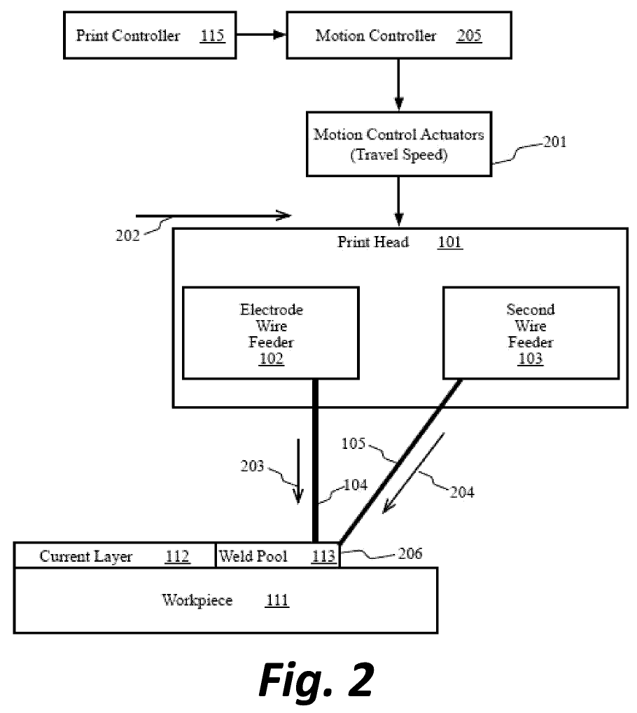

FIG. 2 is a schematic of a deposition system including the print head 101 of FIG. 1 with two wire feeders being moved thereby moving the weld pool 113 in accordance with an embodiment of the invention. A motion controller 205 that is controlled by the print controller 115 may control actuators such as motion control actuators 201. The motion control actuators 201 may be servo motors, stepper motors, hydraulic cylinders, or another actuator means for actuating motion. The motion control actuators 201 can move the print head 101 relative to the workpiece 111. The speed at which the print head 101 moves relative to the workpiece 111 is the travel speed 202. In some embodiments, the print head 101 may be moved while the workpiece 111 remains stationary to produce the travel speed 202. In some embodiments, the workpiece 111 may move while the print head 101 may remain in a certain orientation to produce the travel speed 202. The workpiece 111 may be rotated in a circular motion while the print head 101 remains in a certain orientation. As the print head 101 moves relative to the workpiece 111, the electrode wire 104 can be fed into the weld pool 113 at a first feed rate 203 and the second wire 105 can be fed into the weld pool at a second feed rate 204. FIG. 2 shows the electrode wire 104 and the second wire 105 being fed into the leading edge 206 of the weld pool 113 with the electrode wire 104 behind the second wire 105.

In at least one embodiment, the second wire feeder 103 is controlled by motor actuation or another suitable actuator, while a robot (to which print head 101 is mounted) controls the movement of first wire feeder 102. For example, second wire feeder 103 can be mounted under first wire feeder 102 and utilize a separate movement actuator that can manipulate the position of second wire feeder 103 independent of first wire feeder 102.

In some embodiments, a force sensor may be utilized to calculate at least one of the first feed rate (WFSelectrode), the second feed rate (WFScold wire), and/or the travel speed of the print head 101. The force sensor may be utilized to provide the amount of force that the second wire 105 applies to the workpiece 111. In some examples, the force sensor is utilized to determine whether there is a wire feed issue (e.g. the wire not feeding properly). However, data from the force sensor may also be used to determine the proper positioning of the second wire 105. For example, if a threshold of force is crossed, the height of the second wire 105 with respect to the workpiece 111 may be increased or decreased. This may be performed by increasing or decreasing the second feed rate (WFScold wire). Or the positioning of the second wire 105 may be altered with respect to the electrode wire 104.

In some embodiments, there may also be one or more positioning sensors to sense the positioning of the electrode wire 104. It may be advantageous to monitor the positioning of the electrode wire 104 with respect to the workpiece 111 to monitor whether the electrode wire 104 is both adequately axially positioned and radially positioned during the print. Axial positioning refers to whether the electrode wire 104 is positioned too high or too low with respect to the workpiece 111. The one or more positioning sensors may include an optical sensor (e.g. a camera) which monitors the axial position of the electrode wire 104 with respect to the workpiece 111. The one or more positioning sensors may include a force sensor which may be configured to monitor the axial positioning of the electrode wire 104 with respect to the workpiece 111. For example, if a threshold of force is crossed, it may be determined that the axial positioning of the electrode wire 104 may be incorrect and the height of electrode wire 104 with respect to the workpiece 111 may be increased or decreased. This may be performed by increasing or decreasing the first feed rate (WFSelectrode). Or, the positioning of the electrode wire 104 may be altered with respect to the second wire 105.

Radial positioning refers to whether the electrode wire 104 is positioned in the correct horizontal position with respect to the workpiece 111. The electrode wire 104 may be positioned off center from the workpiece and thus not printing in the proper positioning. Thus, proper radial positioning is advantageous to increasing print quality. The one or more positioning sensors may include a thickness sensor which may be utilized to sense radial positioning. The thickness sensor may be a laser profile scanner which may be used to determine where the boundaries in space are of the sidewalls of the workpiece 111. If the thickness sensor senses that the radial positioning of the electrode wire 104 is incorrect, the radial positioning of the electrode wire 104 is altered.

As illustrated in FIG. 2, the second wire 105 may be fed into the weld pool 113 ahead of the electrode wire 104. However, in some embodiments, the second wire 105 may be fed into the weld pool 113 behind the electrode wire 104. For example, the second wire 105 may be fed into the weld pool 113 behind the electrode wire 104 and behind the leading edge 206 (further described below) of the weld pool 113.

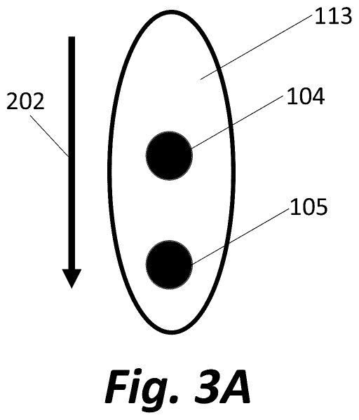

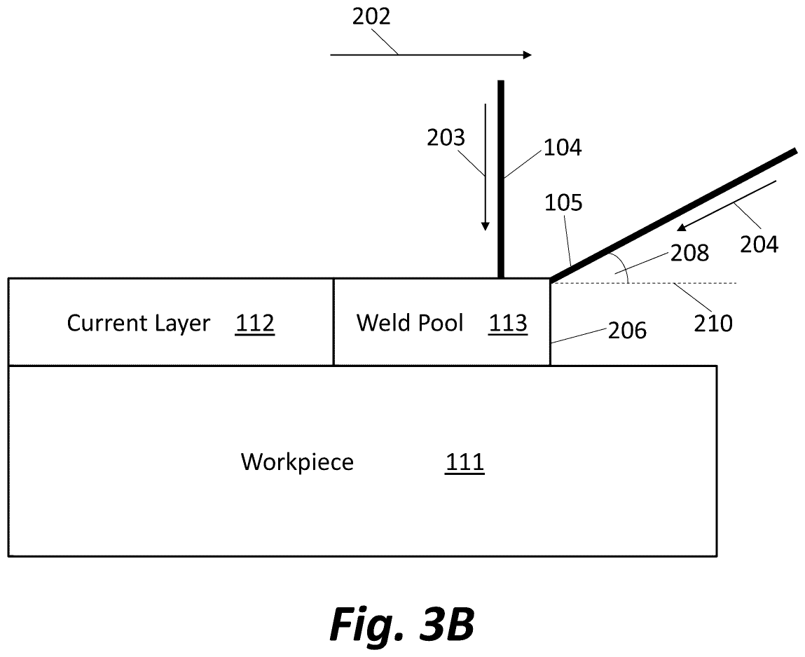

The inventors discovered that certain material types benefit from the second wire 105 being fed behind the electrode wire 104 and certain material types benefit from being fed from in front of the electrode wire 104. FIG. 3A schematically illustrates a top-down view of the deposition system of FIGS. 1 and 2 in accordance with an embodiment of the invention. As illustrated, the second wire 105 is fed into the weld pool 113 ahead of the electrode wire 104.

The inventors discovered that, in cases where the second wire 105 is fed in front of the electrode wire 104, certain angles that the second wire 105 contacts the weld pool 113 are more beneficial than others. FIG. 3B illustrates a magnified schematic of the deposition system of FIG. 2. To simplify the diagram, many components have not been shown and are illustrated in detail in FIGS. 1 and 2. As is illustrated, the second wire 105 may be fed in a certain angle 208 with respect to a horizontal line 210 extending from the weld pool 113. The inventors discovered that, when the second wire 105 is fed in front of the electrode wire 104, the placement of the second wire 105 in front of the electrode wire 104 at a shallow angle has implications for the effectiveness of the shield gas. If the angle 208 is too high the second wire 105 may create shadows on the weld pool 113 where the shield gas is prevented from flowing onto the weld pool 113, which may lead to defects. Further, if the angle 208 is too high, the second wire 105 may not contact enough of the weld pool 113 to sufficiently melt. The more vertically the second wire 105 enters the weld pool 113, the less time the second wire 105 has to melt before contacting the workpiece 111. Ideally, the weld pool 113 completely melts the second wire 105 and solid portions of the second wire 105 do not contact the workpiece 111. However, if the angle 208 is too low, the second wire 105 may impinge on the workpiece 111 which may damage the workpiece 111 or make it difficult to properly position the second wire 105. In some embodiments, the angle 208 may be between about 8-22 degrees, or about 9-21 degrees, or about 10-20 degrees, with these ranges inclusive of their endpoints. In some embodiments, the angle 208 may be greater than or equal to about 10 degrees. In some embodiments, the angle 208 may be less than or equal to about 10 degrees. In some embodiments, the second wire 105 may be fed almost parallel to the workpiece 111 which would make the angle 208 substantially zero.

Feeding the second wire 105 in front or behind the electrode wire 104 may have advantages over one another in certain situations. Further, the exact feed location of the second wire 105 has certain implications. For example, positioning the electrode wire 104 ahead of the second wire 105 may deposit energy at the very forward edge of the melt pool 113 and may improve adhesion between the layers. Positioning the second wire 105 ahead of the electrode wire 104 may help ensure that the material deposited by the second wire passes through the hottest sections of the weld pool 113. Feeding the second wire 105 into the weld pool 113 behind the leading edge 206 may help control the cooling profile behind the leading edge 206.

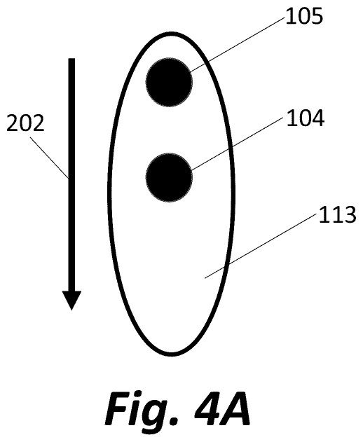

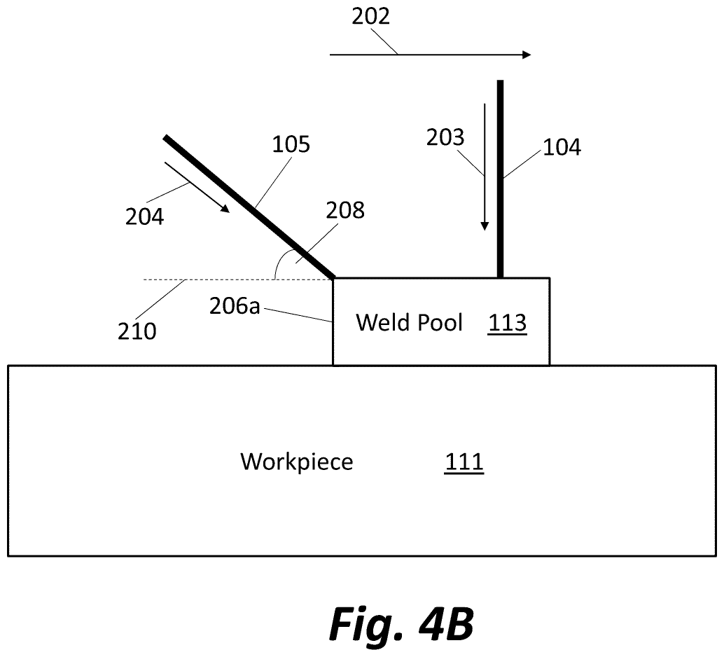

As noted previously, certain material types benefit from the second wire 105 being fed behind the electrode wire 104 and certain material types benefit from being fed from in front of the electrode wire 104. FIG. 4A schematically illustrates a top-down view of the deposition system in accordance with an embodiment of the invention. As illustrated, the second wire 105 is fed into the weld pool 113 behind the electrode wire 104. The second wire 105 may be a material with a higher melting temperature and may be slower cooling, which makes it beneficial to feed behind the electrode wire 104. For example, the inventors discovered that, when the second wire 105 comprises Inconel (Ni—Cr), the second wire 105 may be fed from behind the electrode wire 104. Further, when the second wire 105 comprises a ferrite material, the second wire 105 may be fed behind the electrode wire 104. Further, when the second wire 105 comprises titanium, the second wire 105 may be fed behind the electrode wire 104.

FIG. 4B illustrates a magnified schematic of a deposition system in accordance with an embodiment of the invention. Similar to in FIG. 3B, this deposition system includes the features of the deposition system described in connection with FIGS. 1 and 2. However, the second wire 105 is fed behind the electrode wire 104 at a trailing edge 206a of the weld pool 113. While the current layer 112 has been omitted to better illustrate the placement of the second wire 105, it is understood that the current layer 112 would be present similar to that in FIGS. 1, 2, and 3B. In some embodiments, when the second wire 105 is a material with a higher melting temperature and is slower cooling, the second wire 105 may benefit from preheating before entering the melt pool 113. The second wire 105 may be preheated by applying a voltage to the second wire 105 similar to the electrode wire 104. The voltage may not be enough, by itself, to heat the second wire 105 to melting; however, introduction to the melt pool 113 may further heat the second wire 105 causing it to melt. As with the description of FIG. 3B, the second wire 105 may be fed in a certain angle 208 with respect to a horizontal line 210 extending from the weld pool 113.

The inventors discovered that positioning the second wire 105 before the electrode wire 104 does not shadow the shield gas and thus the angle 208 may be higher than that described in connection with FIG. 3B. However, feeding the second wire 105 too shallowly may result in disruptions to the deposition process. When the second wire 105 is preheated, the second wire 105 may deposit too early in the weld pool 113, resulting in the material balling up due to the thermal energy of the arc, which can cause large amounts of material to be fed in inconsistently. However, if the angle 208 is too high, the second wire may not contact enough of the weld pool 113 to sufficiently melt. The more vertically the second wire 105 enters the weld pool 113, the less time the second wire 105 has to melt before contacting the workpiece 111. Ideally, the weld pool 113 completely melts the second wire 105 and solid portions of the second wire 105 do not contact the workpiece 111. In some embodiments, the angle 208 may be about 30-50 degrees, or about 32-48 degrees, or about 33-47 degrees, with the ranges inclusive of their endpoints. In some embodiments, the angle 208 may be about 45 degrees. In some embodiments, the angle 208 may be greater than about 20 degrees.

When the second wire 105 is made of a lower melting temperature and faster cooling material than the first wire, the second wire 105 is fed from in front the electrode wire 104. This configuration is illustrated and described in detail in connection with FIGS. 1, 2, and 3B. Without limitation to any particular theory, materials that cool quickly create defects (e.g. crusts) on the top of the new current layer. Having the second wire 105 come in from the front means there may be more precision with respect to the height of the workpiece 111: too high and the weld pool 113 may be interrupted.

For example, the inventors discovered that when the second wire 105 comprises aluminum, the second wire 105 may be fed from the front of the electrode wire 104. Also, when the second wire 105 comprises a non-ferrite material, the second wire 105 may be fed from in front of the electrode wire 104. Further, when the second wire 105 comprises copper (e.g. bronze), the second wire 105 may be fed from in front of the electrode wire 104.

In some embodiments, it may be beneficial to feed the second wire 105 from in front of the electrode wire 104 when the second wire 105 includes the example compositions discussed above and described in U.S. Patent Application Publication No. 2023/0313345 and U.S. Patent Application Publication No. 2024/0026497 (both incorporated by reference above).

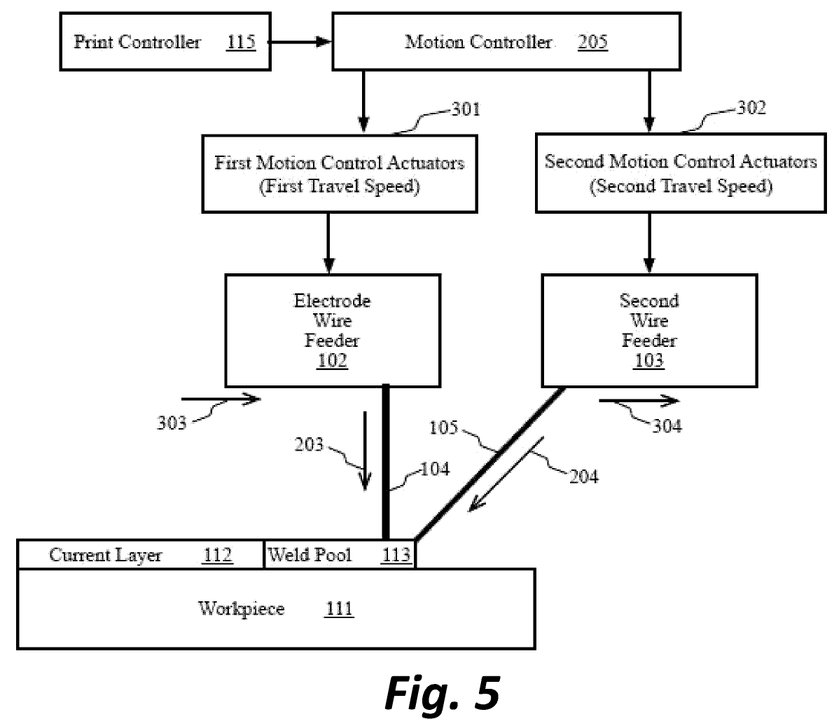

FIG. 5 is a schematic of a deposition system illustrating the workpiece 111 being moved relative to an electrode wire feeder 102 to thereby move a weld pool 113 while a second wire feeder 103 deposits additional material into the weld pool 113 in accordance with an embodiment of the invention. The motion controller 205 may be controlled by the print controller 115 and may in turn control actuators such as first motion control actuators 301 and second motion control actuators 302. The optional first motion control actuators 301 can move the electrode wire feeder 102 relative to the workpiece 111. Moving the electrode wire feeder 102 relative to the workpiece 111 also moves the weld pool 113 relative to the workpiece 111. Alternative suitable movement configurations are described above with reference to FIG. 2. The workpiece 111 moves relative to electrode wire feeder 102 and the second wire feeder 103 at a travel speed 303. The workpiece 111 may be moved while the electrode wire feeder 102 and the second wire feeder 103 remain stationary.

In some embodiments, the second wire feeder 103 may be moved independently from the electrode wire feeder 102. In some embodiments, the second wire feeder 103 and the electrode wire feeder 102 are positioned on a build head which may be moved as a unit. The build head may position the second wire feeder 103 and the electrode wire feeder 102 closer and further away from each other.

As discussed above, more than two wires may be utilized. For example, a single electrode wire may be used and then two cold wires may be fed into the weld pool. FIG. 6 is a schematic of a top-down view of a multi-wire deposition system in accordance with an embodiment of the invention. The multi-wire deposition system includes an electrode wire 452. A voltage may be applied to the electrode wire 452 to produce a weld pool 113. A second wire 454 may be fed into the weld pool 113 in a first direction 454a. A third wire 456 may be fed into the weld pool 113 in a second direction 456a. In some embodiments, the second wire 454 and the third wire 456 may be oriented in a ‘V’ shape with a certain angle between them. The inventors discovered that a smaller angle between the second wire 454 and the third wire 456 may be advantageous. However, there may be equipment limitations which may limit how small an angle may be between the second wire 454 and the third wire 456. In some embodiments, multiple cold wires may be fed into the weld pool. The multiple cold wires may surround the electrode wire. Any number of cold wire such as 1 cold wire, or 2 cold wires, or 3 cold wires, or 4 cold wires, or 5 cold wires, or more than 5 cold wires can be fed into the weld pool.

In some embodiments, the second wire 454 and a third wire 456 may be in orientations which contact the weld pool 113 in parallel lines. The second wire 454 and the third wire 456 may be cold wires are not applied a voltage. In some embodiments, the second wire 454 and/or the third wire 456 may be preheated. The preheating may be performed by applying a voltage to the second wire 454 and/or the third wire 456.

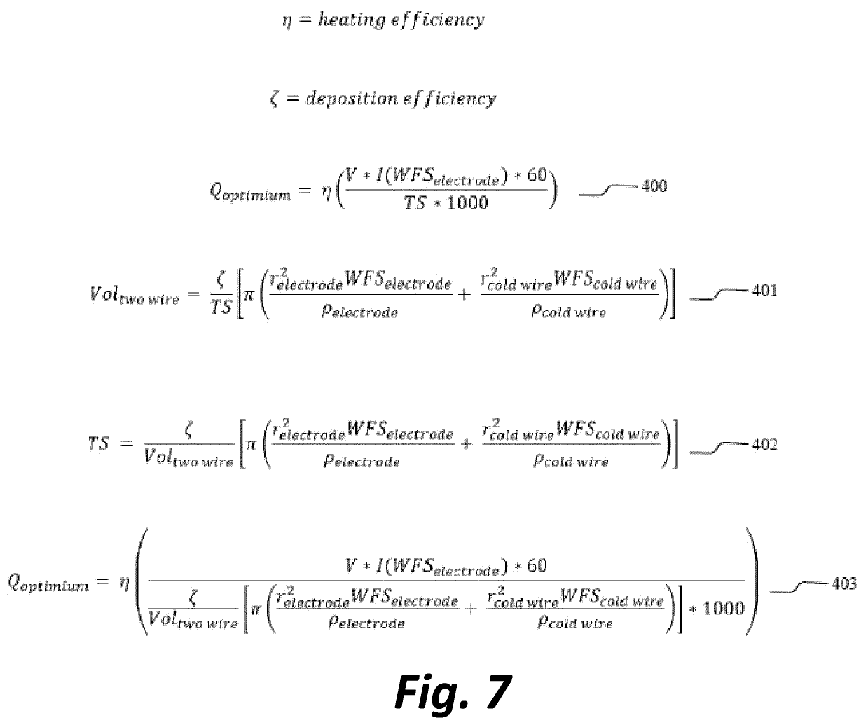

FIG. 7 is a diagram that illustrates equations that model a relationship between a Q value and other parameters of a two-wire deposition process. The heating efficiency, n, is a constant value that is a known property of the electrode wire. The heating efficiency may be determined experimentally if it is not known. The deposition efficiency, Z, is a constant value that is a known property of the electrode wire. The deposition efficiency may be determined experimentally if it is not known. The input voltage, ζ, is the voltage supplied via the electric power source. The input current, I(WFSelectrode), is the electrode current. The input electric power is the input voltage multiplied by the input current. A power value can indicate the amount of input electric power provided by the electric power source. The power value can be calculated using measurements of the input voltage and the input current. As discussed above, the electrode current is a function of the first feed rate, WFSelectrode. As such, the power value is also a function of the first feed rate, WFSelectrode. The travel speed, TS, is the speed at which the weld pool is moved relative to a stationary point on the workpiece. In some embodiments, moving the electrode end moves the weld pool and moving the electrode wire feeder moves the electrode end. In some embodiments, the electrode end is generally stationary, and the workpiece moves (e.g., rotates) relative to the electrode end. In either case, TS can be the travel speed of the electrode wire feeder relative to the workpiece as one moves relative to the other. When a print head includes the electrode wire feeder, TS can be the travel speed of the print head relative to the workpiece. A first equation 400 can be used to calculate the Q value (Qoptimum) as a function of the heating efficiency, the power value, and the travel speed.

The Q value may be interpreted as a value based on the amount of energy being deposited into the weld pool by the electrode wire. The Q value can be determined by the first equation 400. The first equation 400 does not reference the second wire, as such the Q value determined using the first equation 400 is not a function of the second feed rate or other parameters of the second wire. The second equation 401 can be used to determine the weight (p is used to indicate the density of a material) of the material deposited into the weld pool per unit length along the workpiece. The second equation 401 assumes wire with circular cross-sections. As such, the r2 terms and the IT outside the parentheses indicate that the area of a circular cross-section is multiplied by a length per unit time (WFS). Those practiced in geometrical calculations (e.g., most undergraduate engineers) realize that the second equation 401 may be adapted for embodiments using wires having non-circular cross-sections and to embodiments using additional wires such as a third wire, fourth wire, etc. Solving the second equation 401 for the travel speed, TS, produces the third equation 402. Replacing the travel speed, TS, in the first equation 400 with the right-side expression of the third equation 402 produces the fourth equation 403. The Q value can be determined using the first equation 400. Having determined the Q value, the fourth equation 403 may be used to determine the second wire feed rate, WFScold wire. According to the model, using the second feed rate for the second wire maximizes the material deposition rate. For example, a numerical method such as one of the many successive approximation methods may be used to determine WFScold wire. After using the model to determine the second wire feed rate, the second wire can be fed into the weld pool at the second wire feed rate to thereby maximize the material deposition rate according to the model. The material deposition rate is the sum of the electrode wire deposition rate and the second wire deposition rate. The electrode wire deposition rate is the rate at which the electrode wire deposits material into the weld pool. The second wire deposition rate is the rate at which the second wire deposits material into the weld pool.

In some cases, running below the maximal threshold and at an optimal feed rate may be advantageous. Thus, the equations in FIG. 7 are merely examples rather than necessary criteria by which parameter feed rate is set.

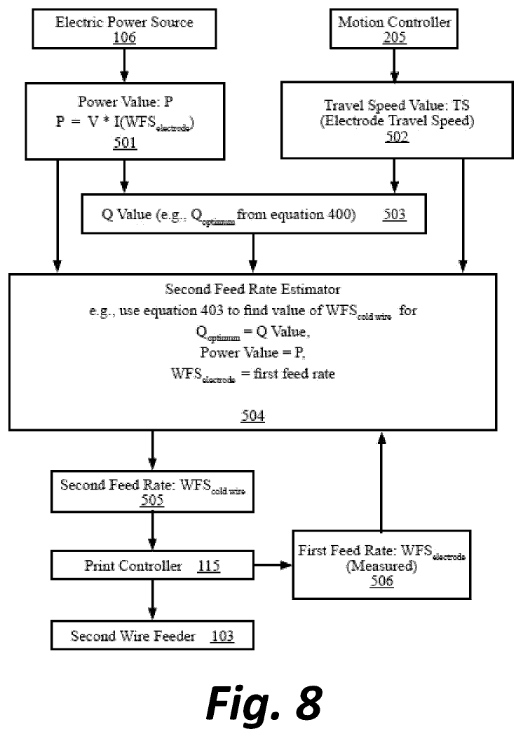

FIG. 8 is a high-level diagram illustrating a second feed rate estimator 504 that determines a feed rate for the second wire. A power value 501, P, can indicate the amount of input electric power produced by the electric power source 106. The travel speed value 502, TS, can indicate the speed at which the weld pool moves relative to the workpiece. TS can be measured by measuring the speed at which the weld pool, electrode end, electrode wire feeder, or print head is moved. TS may be a readable parameter provided by the motion controller 205 because the electrode end, electrode wire feeder, and print head are moved at a speed that is controlled by the motion controller 205. The first equation 400 can be used to determine the Q value 503 by using the power value 501, travel speed value 502, and constant values such as the heating efficiency. The constant values are values that are treated as nonchanging, or constant, during a printing operation (e.g., heating efficiency, deposition efficiency, electrode wire radius (relectrode), second wire radius (rcold wire), etc.) The second feed rate estimator 504 can use the fourth equation 403 to estimate the second feed rate 505, WFScold wire, based on current values of the Q value, power value, and first feed rate. The value determined for the second feed rate 505 can be sent to the print controller 115 such that the second wire feeder 103 feeds out the second wire at the second feed rate. The print controller may also provide the current value of the first feed rate 506. The first feed rate 506 can be a measured value determined by measuring the rate at which the electrode wire is fed in the weld pool. The first feed rate may be a readable parameter provided by the print controller 115 (or motion controller if the motion controller controls the wire feeders) when the electrode wire is fed at a speed that is controlled by the print controller 115.

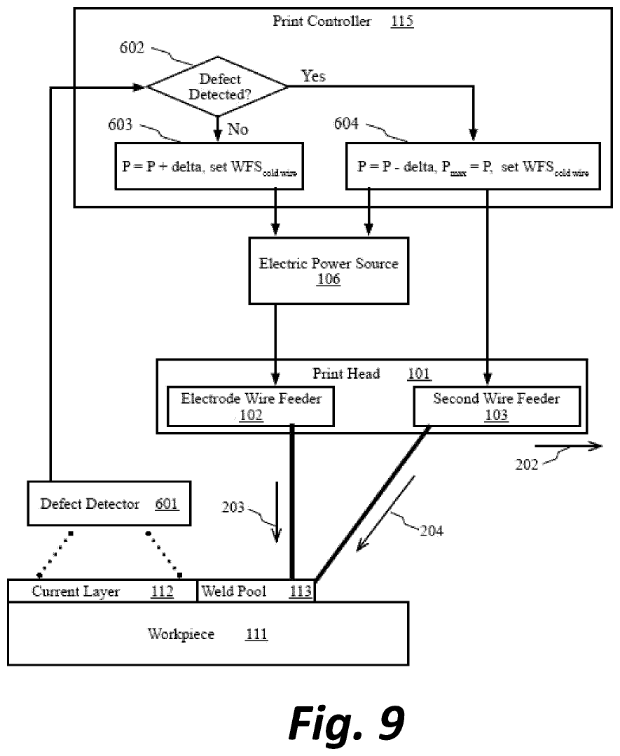

FIG. 9 is a high-level diagram that illustrates using a defect detector 601 to optimize input electric power. Those practiced in welding, steel construction, and related fields are familiar with a variety of defect detectors that can detect flaws in a weld. The defect detector may detect voids, metal dripping, weld spatter, and other defects when the printing process is producing a flawed workpiece. The defect detector 601 can send a defect detected signal to the print controller 115 when a defect is detected. The print controller 115 can implement a power adjustment process that adjusts the input electric power based on whether a defect is currently detected. At decision block 602, the power adjustment process can determine whether a defect is currently detected. If a defect is detected at decision block 602, the process can reduce the input electric power by a set amount, delta, may set a maximum power threshold value, Pmax, and can set the second feed rate. Pmax can indicate the maximum allowable input electric power. The second feed rate may be changed when the second feed rate is a function of input electric power, P. The second feed rate can also be a function of other parameters (e.g., travel speed, TS). If no defect is detected at decision block 602, the process can increase the input electric power by a set amount, delta, and can set the second feed rate. The input electric power may be limited such that it does not exceed Pmax. The second feed rate may be changed when the second feed rate is a function of input electric power. The “delta” term indicates a value by which a parameter can be adjusted. The value used for a delta may be different in different settings (e.g., block 603 and block 604) and at different times. As discussed above, the second feed rate can be a function of parameters such as the input electric power. A model such as the model in FIG. 7 can be used to determine a new value for the second feed rate based on the new value for the Input electric power. The print controller can adjust the printing process to use the new input electric power and the new second feed rate.

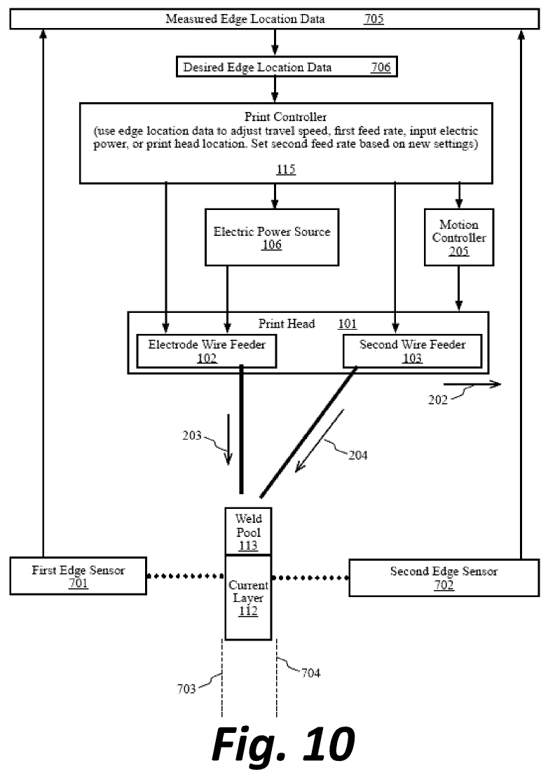

FIG. 10 is a high-level diagram that illustrates using edge sensors to optimize input electric power and other process parameters. A first edge sensor 701 and a second edge sensor 702 can produce measured edge location data 705 that indicates the locations of the edges of the current layer behind the weld pool. Desired edge location data 706 can indicate the locations where the edges should be. A first desired edge location 703 can indicate the desired location of the edge measured by the first edge sensor 701. A second desired edge location 704 can indicate the desired location of the edge measured by the second edge sensor 702. Comparing the measured edge location data 705 and the desired edge location data 706 may indicate that the current layer is shifted from its desired location. As such, the print controller may shift the print head such that the measured edge locations are at the desired edge locations.

Comparing the measured edge location data 705 and the desired edge location data 706 may indicate that the current layer is too thin. As such, the print controller may adjust the printing parameters such that more material is deposited per unit length (e.g., decrease TS). Comparing the measured edge location data 705 and the desired edge location data 706 may indicate that the current layer is too thick. As such, the print controller may adjust the printing parameters such that less material is deposited per unit length (e.g., increase TS). As discussed above, the second feed rate can be a function of parameters such as TS. A model such as the model in FIG. 7 can be used to determine a new value for the second feed rate based on the new value for the travel speed, TS. The print controller can adjust the printing process to use the new travel speed and the new second feed rate.

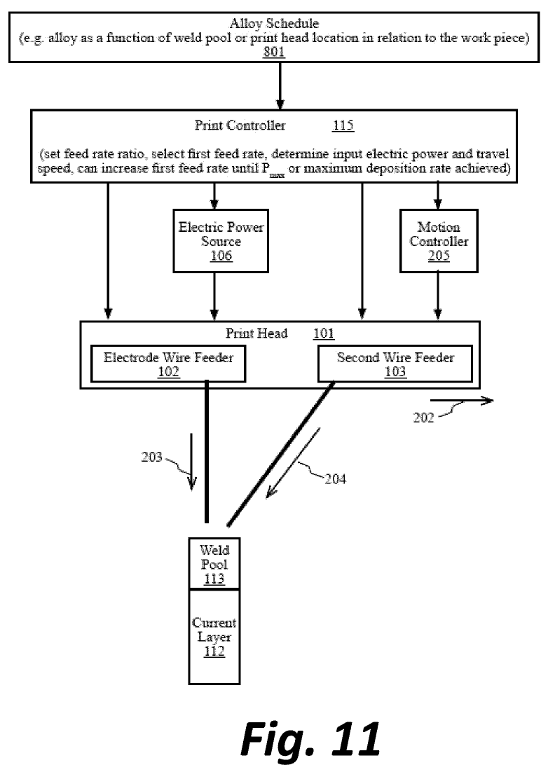

FIG. 11 is a high-level diagram that illustrates using an alloy schedule 801 to deposit different alloys at different locations in a structure. The alloy schedule can indicate the ratio of material to be deposited at different locations in the workpiece to thereby deposit a desired alloy at those locations. As such, the desired alloy can be a function of the weld pool location, electrode wire feeder locations, print head locations, etc. For example, depositing two units of material from the electrode wire and one unit of material from the second wire can produce a first alloy while depositing two units of material from the electrode wire and two units of material from the second wire can produce a second alloy. The alloy schedule 801 may indicate that the lowest meter of a cylindrical workpiece is to be the first alloy and that the second lowest meter is to be the second alloy. A mathematical model, such as that shown in FIG. 7, can be used to determine values for the input power, the travel speed, and the feed rates such that the desired alloy is produced. More specifically, for the first alloy 0.5*WFSelectrode can be used instead of WFScold wire in the fourth equation 403. A numerical method such as one of the many successive approximation methods may be used to determine values for the input electric power, travel speed, and WFSelectrode that produce the desired alloy. It may be necessary to iterate using both the first equation 400 and the fourth equation 403 to determine the values. Changes in a parameter (e.g., P due to detected defects or TS to adjust weld pool width) may require using the model to determine the other printing parameters.

Manufacturing a large-scale part in a vertical orientation may be impracticable in some instances. It may be possible to house printing in a facility tall enough to accommodate all vertically printed parts. For a 10-meter-tall part, a building with greater than 10 meters of vertical open space would need to be utilized. When the large-scale part is very tall, such as in the case of a rocket, when printed in a vertical orientation, the vertical height of the part can exceed the vertical open space of an industrial factory. Accordingly, it can be advantageous to be able to print parts in a horizontal orientation. When printing in a horizontal orientation, instead of a 10-meter-tall building, a 10-meter-long building could be used to accommodate the printing process. Further, when printing in a horizontal orientation, the effects of gravity may make certain orientations of the print head and the workpiece more beneficial. As described in greater detail in U.S. Patent Application Publication No. 2024/0017340, published Jan. 18, 2024, which is hereby incorporated by reference, positioning the build head along the horizontal meridian of a circular build plate, e.g., at a 9 o'clock position if the circular build plate is analogized to a clock face, allows gravity to be in line with the travel direction of the workpiece when the workpiece mounted to the build plate is rotated in a clockwise direction. Likewise, in cases where the workpiece is rotated in a counterclockwise direction, positioning the build head at a 3 o'clock position allows gravity to be in line with the travel direction of the workpiece.

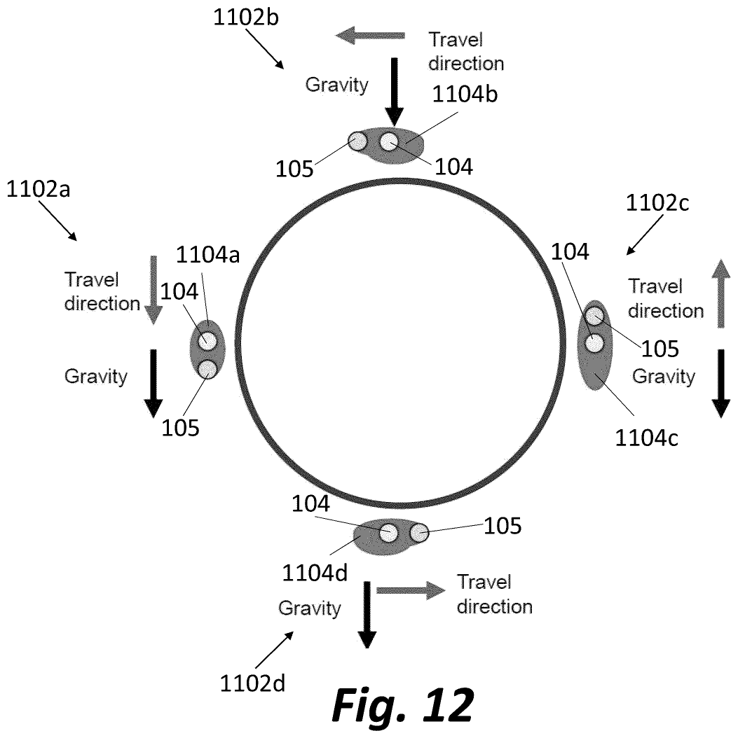

FIG. 12 schematically illustrates different positionings of the print head with respect to the workpiece to demonstrate the effects of gravity on the melt pool. In a horizontal meridian print position 1102a (e.g. a 9 o'clock print position), gravity is in line with the travel direction of the workpiece when the workpiece is rotated in a clockwise direction. Thus, the electrode wire 104 melts into a weld pool 1104a, the weld pool 1104a is more compact and hotter which allows the second wire 105 to melt easier. In comparison, when the print head is in a vertical meridian print position 1102b (e.g. 12 o'clock position), the weld pool 1104b is distorted because gravity is perpendicular to the travel direction. Similarly, when the print head is in the 6 o'clock position 1102d, the weld pool 1104d is distorted because gravity is perpendicular to the travel direction. The distortion when the print head is in the 12 o'clock or 6 o'clock position may produce non-uniform/asymmetric deposition. Further, when the print head is in the 3 o'clock position 1102c, the travel direction is opposite gravity and thus the weld pool 1104c is elongated. The elongated weld pool 1104c may disperse the heat of the weld pool 1104c which may make it more difficult to melt the second wire 105.

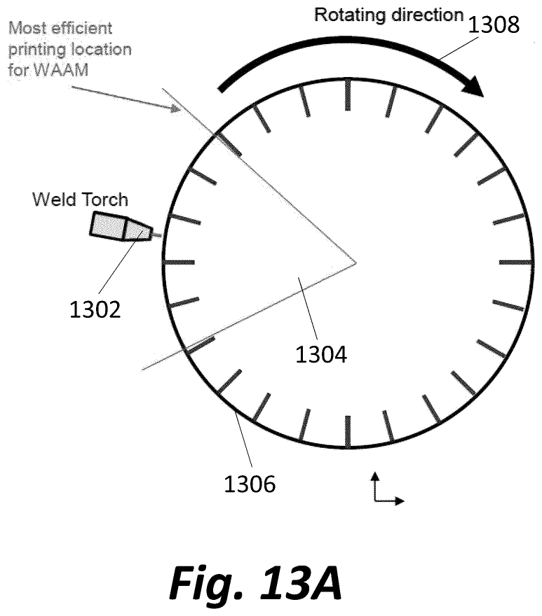

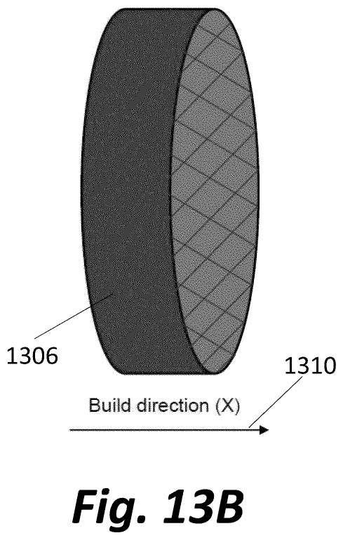

FIG. 13A illustrates a schematic of a system for printing with a print head in accordance with an embodiment of the invention. As illustrated, the print head 1302 may be used to print on a workpiece 1306 with the workpiece 1306 being rotated in a clockwise direction 1308. The print head 1302 may be located in a certain orientation 1304 which allows gravity to be substantially aligned with the travel direction of the print head 1302. As illustrated, the orientation 1304 may place the print head 1302 at the 9 o'clock orientation with respect to the workpiece 1306. FIG. 13B illustrates a schematic perspective view of the workpiece 1306 during building with the system of FIG. 13A. The workpiece 1306 includes a horizontal build direction 1310 which may be advantageous for certain high aspect ratio prints.

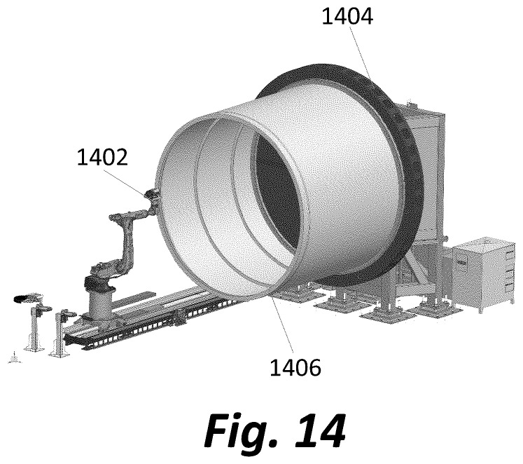

FIG. 14 is a perspective view of a schematic of an example horizontal print system. The system includes a print head 1402 which prints a workpiece 1406 on top of a build plate 1404. Examples of the build plate 1404 are described in U.S. patent application Ser. No. 18/352,995, entitled “Horizontal Metal 3-D Printer Build Plate” and filed on Jul. 14, 2023, which is incorporated by reference in its entirety for all purposes. Further, examples of a horizontal print cell including the build plate 1404 are described in U.S. patent application Ser. No. 18/352,992 (incorporated by reference above). The build plate 1404 may be rotated in a clockwise direction during the build process in order to move the weld pool across the workpiece 1406. As illustrated, the print head 1402 may be positioned to print the workpiece 1406 on the build plate 1404 at a position on the build plate's horizontal meridian (e.g. a 9 o'clock orientation). As discussed previously, this allows the travel direction to align with the direction of gravity.

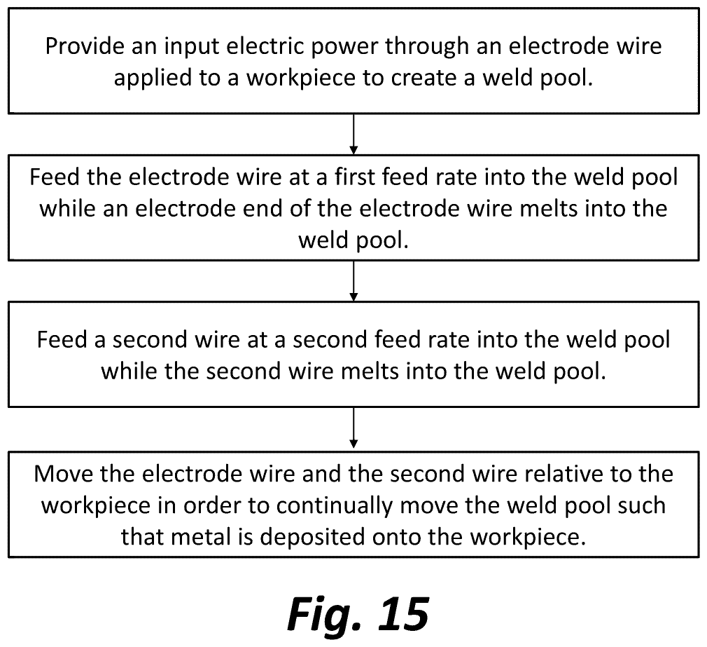

FIG. 15 is a flow chart of a method 1500 for depositing material using multiple feed wires in accordance with an embodiment of the invention. The method 1500 includes providing (1502) an input electric power through an electrode wire applied to a workpiece to create a weld pool. The voltage can create a current which flows through the electrode wire onto the workpiece. At the interface of the electrode wire and the workpiece there may be heat which melts the electrode wire to create the weld pool.

The method further includes feeding (1504) the electrode wire at a first feed rate into the weld pool while an electrode end of the electrode wire melts into the weld pool. The heat of the weld pool melts the electrode wire. The faster the first feed rate the more power is applied to the weld pool which increases the heat in the weld pool. Increased heat may create defects in the deposited metal which may be disadvantageous.

The method further includes feeding (1506) a second wire at a second feed rate into the weld pool while the second wire melts into the weld pool. The second wire may be a cold wire and thus no voltage may be applied to the second wire. The heat in the weld pool may be used to melt the second wire without adding additional heat to the deposition process. Thus, the second feed rate of the second wire may be used to balance the first feed rate of the electrode wire to decrease the number of defects while increasing deposition speed.

The method further includes moving (1508) the electrode wire and the second wire relative to the workpiece in order to continually move the weld pool such that metal is deposited onto the workpiece. As discussed above, such relative movement encompasses maintaining the electrode wire and the second wire generally stationary while the workpiece is rotated thus creating a travel direction for the electrode wire and the second wire relative to the workpiece. The workpiece may be rotated in a clockwise direction. The electrode wire and the second wire may be positioned along the build plate's a horizontal meridian (e.g. a 9 o'clock position relative to the workpiece). The weld pool solidifies to form the deposited metal. The deposited metal may form a printed part.

During deposition, the high energies created through the electrode wire 104 and/or the second wire 105 may create sputtering and/or smoking which can create ventilation problems that may necessitate frequent shutdowns. The sputtering and/or smoking may deposit unwanted material onto the shield gas nozzle around the electrode wire 104 which may need to be periodically removed. It may be advantageous to coat the shield gas nozzle in a coating such as boron nitride or graphite to keep the unwanted material from sticking to the shield gas nozzle. The coating may make the sputter residue less likely to stick to the shield gas nozzle which may allow the system to be easily cleared with a simple gas purge of the system. The shield gas nozzle may have a coaxial shape so that the radius and volume of the shield gas is increased, mitigating the shadowing due to the second wire 105. In this regard, U.S. Patent Application Publication No. 2023/0398606, published Dec. 14, 2023, describes an example shield gas nozzle that includes a concentric or coaxial cylinder. The entirety of that application is incorporated by reference.

### Dual Plasma Wire Arc Additive Manufacturing

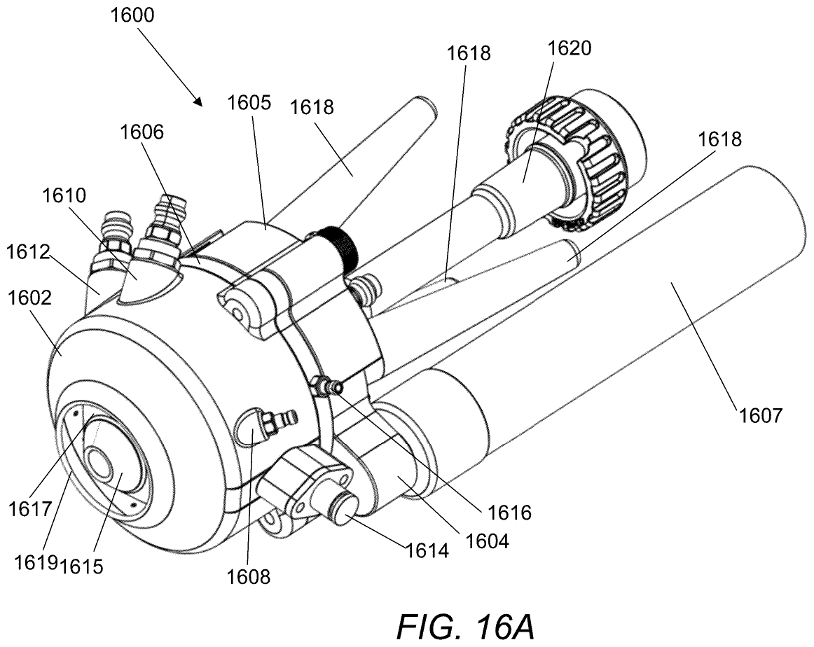

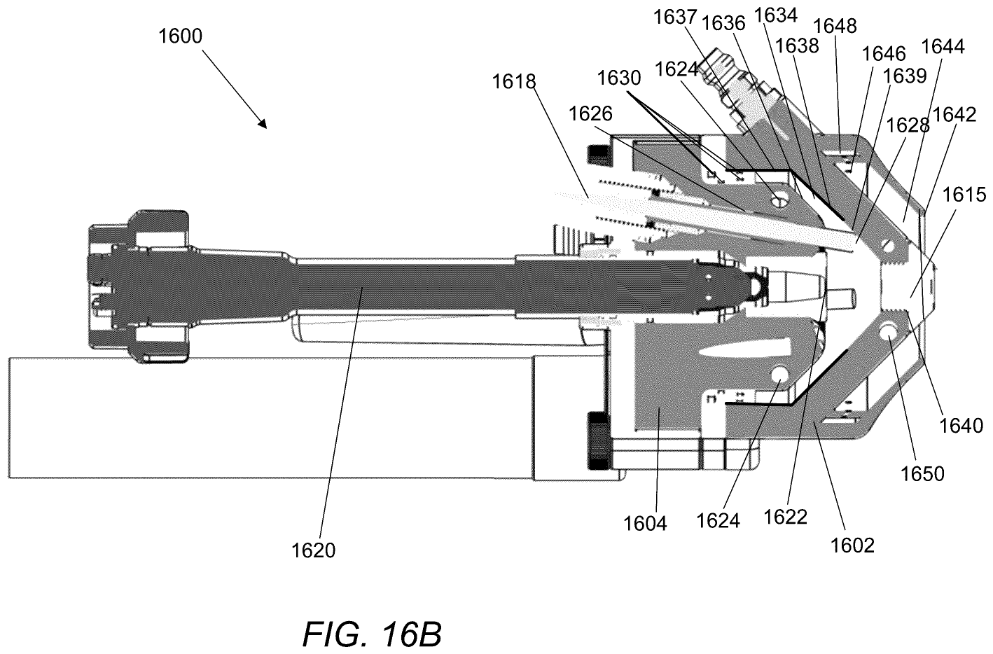

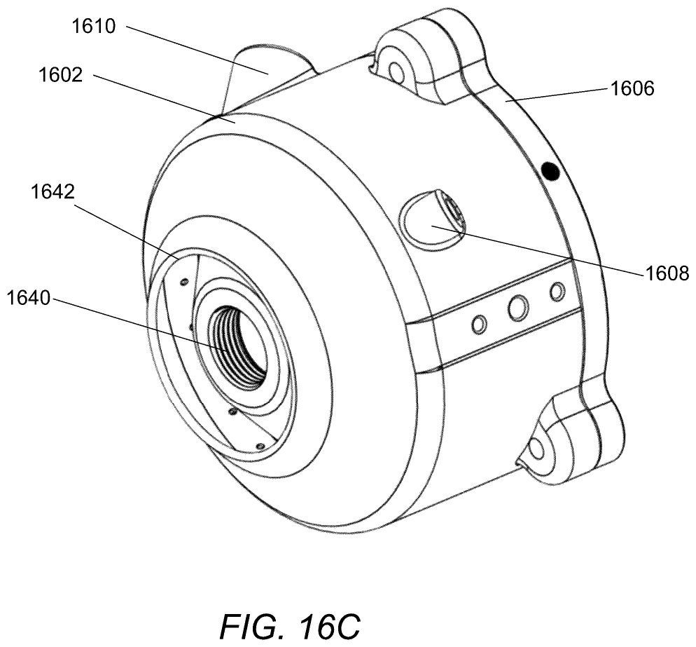

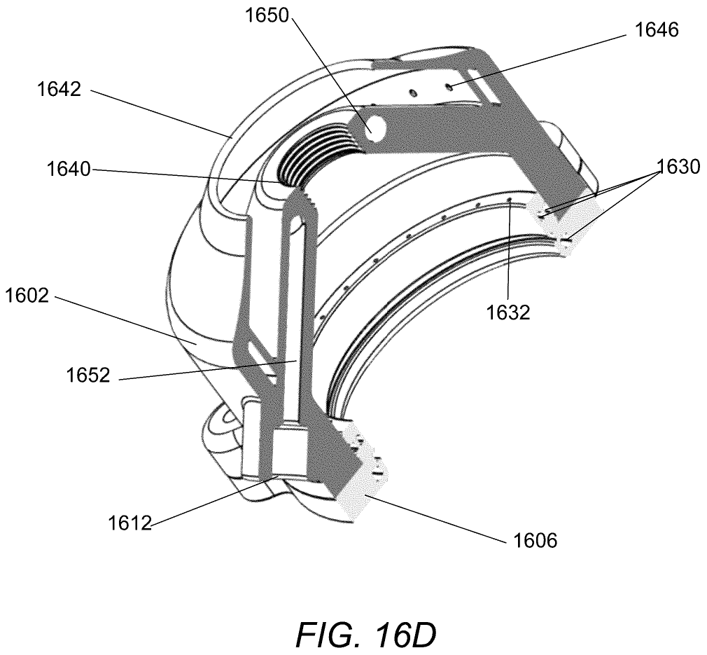

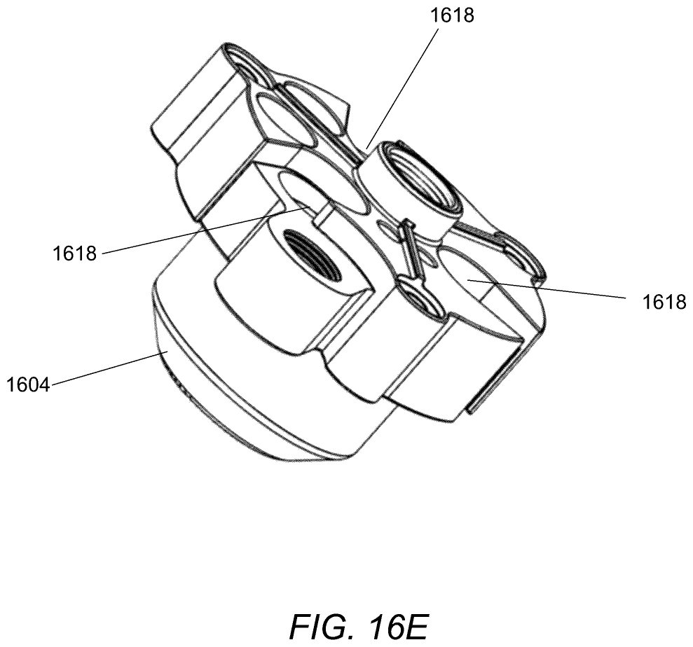

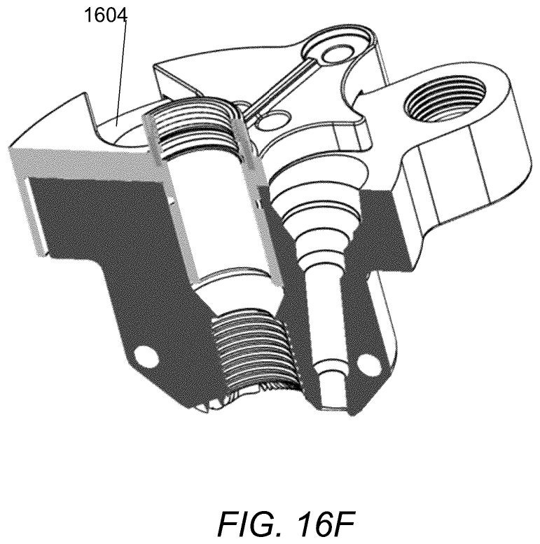

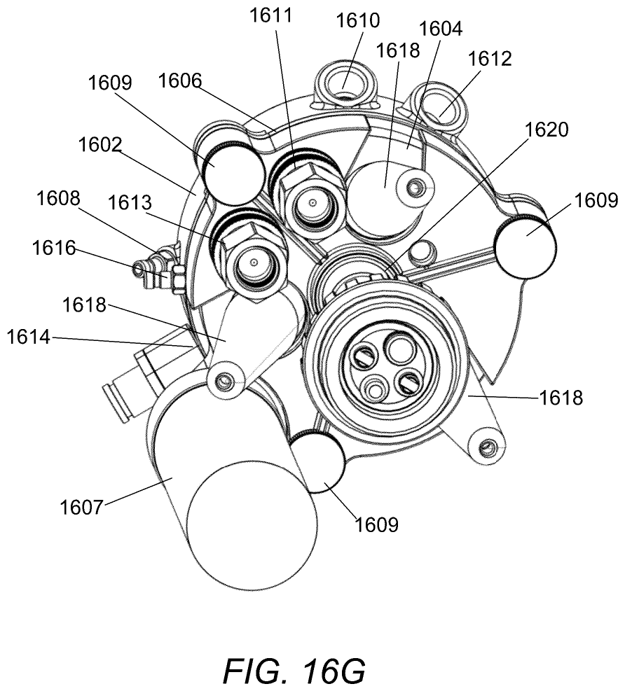

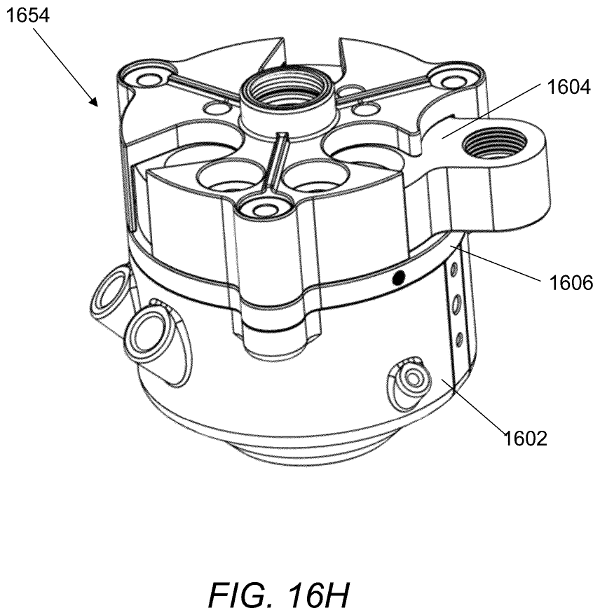

In accordance with several embodiments of the invention, a wire arc additive manufacturing applicator can include a dual plasma aspect (e.g., a dual plasma torch). A first example dual plasma torch assembly is conceptually illustrated in FIGS. 16A-16H. The plasma assisted torch assembly 1600 can include an outer body 1602, and an inner body 1604. The inner body 1604 can nest inside the outer body 1602. A separator 1606 can be disposed between the inner body 1604 and the outer body 1602. A power supply 1607 can connect to the inner body 1604. A plastic portion 1605 can be coupled to the inner body 1604. A plastic portion can, in some embodiments, cover a substantial portion of an inner body.

The outer body 1602 can include a gas port 1608 (e.g., for shielding gas), a coolant port 1610, and/or a second coolant port 1612. A port can be the set of an inlet and/or an outlet. The outer body 1602 can have a grounding connection 1614. The outer body has an insert 1615 mounted to an inner opening 1617. The inner opening can be a circular exit for the assisting plasma. The outer body 1602 can have an outer opening 1619. The outer opening 1619 can be a circular exit for shielding gas. In various embodiments, a coolant inlet, a coolant outlet, a gas port, and/or a grounding connection can be circumferentially disposed on an outer body. Inserts can be made from non-conducting materials (e.g., ceramic). Inserts can be replaceable consumables. Inserts can be useful to prevent a wire (e.g., an aluminum wire) being used as an electrode during a welding process, from bonding with an opening of an outer body.

The separator 1606 can include a gas port 1616 (e.g., for shielding gas).

The inner body 1604 can be attached to electrode assemblies 1618 (e.g., 3 electrodes). The electrode assemblies, in various embodiments, can include electrodes (e.g., tungsten electrodes) and electrode holders. A torch (e.g., a MIG torch) 1620 can be coupled to the inner body 1604. In several embodiments, a central longitudinal axis can be collinear for an inner body, an outer body, and/or a torch. The inner body 1604 can have a coolant port 1611 and a coolant port 1613. The inner body 1604, separator 1606, and outer body 1602 can be fastened together using fasteners 1609.

The torch 1620 can insert into the inner body 1604 from a proximal side. The torch 1620 can include a distal wire holder 1622. The distal wire holder 1622 can be flush (or leveled) with a distal side of the inner body 1604. The inner body 1604 can include a coolant (e.g., a cooling fluid, or a cooling solution, or water) channel 1624. Coolant channels can be annular (e.g., nearly annular) and can be connected with coolant inlets and coolant outlets. Inner body coolant channels can be, in various embodiments, arranged circumferentially around a bottom opening of the inner body. In accordance with embodiments of the invention, an inner body can include inner body cooling channels arranged circumferentially around a bottom opening of the inner body.

A torch can protrude through the bottom opening. The inner body 1604 can include an electrode pathway 1626. The electrode pathway can accommodate the electrode assembly 1618 with a distal tip 1628. Electrode assemblies, in various embodiments, can be positioned such that a distal tip of the electrode is closer to an expected workpiece location than a distal wire holder. The separator 1606 can include dispersion channels 1630. The dispersion channels 1630 can communicate with diffusion holes 1632 (as shown in FIG. 16D). Diffusion holes can be disposed around a circumference of a separator. In various embodiments a separator (e.g., an electrical insulator separator, a plastic separator) spaces and/or insulates an inner body from an outer body. Dispersion channels can communicate with a gas supply. In various embodiments, the gas supply enters one or more dispersion channels and/or is directed through diffusion holes, and into a plasma channel. Ionization of the gas occurs through the electrical current of the arc. A plasma channel can be a space between an inner body and an outer body. During operation the plasma channel can accommodate ionizing gas and/or plasma. Electrodes can generate the plasma. A plasma channel 1634 can be formed by the space defined between a plasma channel surface 1636 of the inner body 1604 and the plasma channel surface 1638 of the outer body 1602. In various embodiments, the plasma channel surface 1636 can be coated with an electrically insulating coating. The plasma channel surface 1638 can have a first portion 1637 and a second portion 1639. The second portion 1639 can be proximal to the electrode 1618. The first portion 1637 can be distal to the electrode 1618. In several embodiments, the first portion 1637 can be coated with an electrically insulating coating, and the second portion 1639 can have a conductive surface.

Gas supply and/or shielding gas can enter the plasma channel 1634 via the diffusion holes and/or dispersion channels 1630. The gas supply and/or the shielding gas can be any chemically inert gas that can shield the feedstock (such as wires) from environmental contamination. The proximal end of the electrode 1618 is in contact with the electrically conductive second portion 1639 of the plasma channel surface 1638. The electrode 1618 can apply a voltage (or a high frequency signal) high enough to create an arc such that a plasma (or ionized gas; or ionized gas stream) is formed from the gas supply and/or the shielding gas. The plasma can act as a second shielding source to the feedstock and/or the workpiece. Additional shielding from the plasma can improve the print qualities of the workpiece. The first portion 1637 of the plasma channel surface 1638 of the outer body 1602 and the plasma channel surface 1636 of the inner body 1604 are electrically insulating so the ionized gas will be created at the electrically conductive second portion 1639. The creation of the plasma can be achieved via dielectric discharge. The plasma discharge can be increased by increasing the surface area of the gas supply and/or by increasing the surface area of the electrically conductive portion of the plasma channel. The created plasma is considered an assisting plasma.

In many embodiments, various inert gases can be used as shielding gas. Examples of the shielding gas include (but are not limited to) argon, helium, neon, xenon, krypton, carbon dioxide, hydrogen, nitrogen, nitric oxide, and any combinations thereof. The high voltage signal (or the high frequency signal) applied to create the assisting plasma can have a frequency between about 0.1 kHz and about 1000 kHz; or between about 0.1 kHz and about 10 KHz; or between about 10 KHz and about 100 kHz; or between about 100 kHz and about 500 KHz; or between about 500 KHz and about 1000 kHz. The voltage signal can be in the range of between about 1 kV and about 50 kV; or between about 1 kV and about 10 kV; or between about 10 kV and about 20 kV; or between about 20 kV and about 30 kV; or between about 30 kV and about 40 kV; or between about 40 kV and about 50 kV.

In accordance with several embodiments of the invention, a plasma channel surface of an inner body can be coated with an electrically insulating material. In some embodiments a plasma channel surface of an outer body can be partially coated with an electrically insulating material. The insulating materials can be (but are not limited to) ceramic materials. In close proximity to an electrode the channel surface of the outer body can be, in many embodiments, electrically conductive. This can be important for forming an initial arc to ignite a plasma inside a plasma channel.

The outer body 1602 can have a plasma aperture 1640 and a shielding gas aperture 1642. In various embodiments the shielding gas aperture is communicatively coupled to a shielding gas supply. The shielding gas aperture 1642 can be at a terminal end of a shielding gas channel 1644. The shielding gas channel 1644 can be supplied with shielding gas through circumferentially arranged diffusing holes 1646. The diffusing holes can receive shielding gas from a circumferential shielding gas supply channel 1648. The outer body 1602 can include a cooling channel 1650. The cooling channel can be positioned circumferentially relative to the aperture 1640. In several embodiments, the aperture can be a bottom opening. The cooling channel 1650 can receive a coolant through an inlet channel and lose coolant through an outlet channel. An outlet channel 1652 is shown in FIG. 16D. An inlet channel can have a similar structure. The aperture 1640 can receive the insert 1615. In several embodiments the aperture 1640 can be threaded. Apertures (e.g., aperture 1640) can be positioned such that the wire electrode can extend up to, into, and/or through such apertures.

The inner body 1604 can include openings (e.g., top openings) for receiving various attachments. Inner bodies can be configured to receive electrodes, and/or coolant. The inner body 1604 can be configured to receive three symmetrically (e.g., 3-way symmetry about the central longitudinal axis) arranged electrodes 1618. Inner bodies can be configured to receive electrodes, coolant ports, torches, and/or fasteners into and/or through top openings.

As shown in FIG. 16H, a nozzle 1654 can include the inner body 1604, the separator 1606, and the outer body 1602.

In several embodiments, the internal cooling channels and/or other internal structures can be realized using additive manufacturing techniques. In many embodiments the internal structures described herein (e.g., the cooling channels, the electrode receivers, torch receivers, fastener receivers, and/or other structures) can be manufactured using additive manufacturing processes. Inner bodies, outer bodies, and/or other components can be manufactured, in accordance with embodiments of the invention, using additive manufacturing. Additive manufacturing can be beneficial where the desired geometries are difficult to achieve through traditional manufacturing.

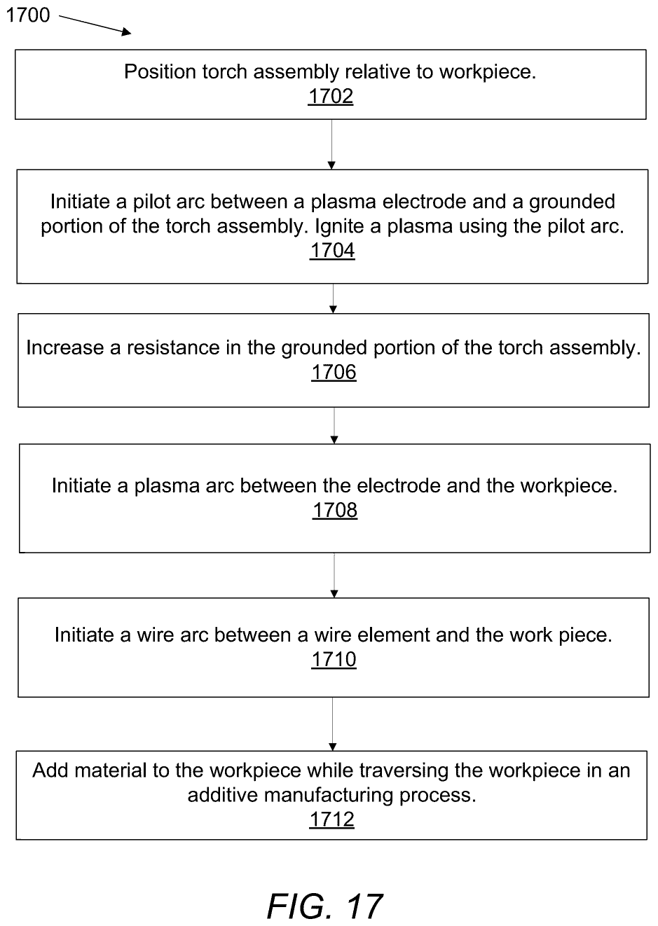

In various embodiments, a manufacturing process can include performing additive manufacturing (e.g., WAAM) using a dual plasma torch aspect. This manufacturing can be known as dual plasma wire arc additive manufacturing. An example process for additive manufacturing using a dual plasma torch is conceptually illustrated in FIG. 17. The additive manufacturing process 1700 can be a WAAM process. A torch assembly can be positioned (1702) relative to a work piece.

As explained next, a pilot arc is initiated between the second (e.g., tungsten) electrode and the outer nozzle; the pilot arc is used to ignite the plasma arc between the electrode and the workpiece; and then the pilot arc is shut off. A pilot arc can be ignited (1704) utilizing high frequency to ionize the area between a secondary (e.g., tungsten) electrode and a grounded portion of the torch assembly. Accordingly, the pilot arc can be an arc between an electrode and a grounded portion of, for example, an outer-body portion of a nozzle. In some embodiments, the pilot arc is a plasma ignition arc that can ignite a plasma arc. The plasma arc can be initiated (1708) between the electrode and the workpiece. The plasma arc can facilitate a plasma stream to the workpiece. In some embodiments, initiating the plasma arc can coincide with the dissipation of the pilot arc. To facilitate maintaining the pilot arc between the second (tungsten) electrode and the workpiece, the pilot arc circuit is rapidly disconnected when the plasma arc circuit is established. The plasma arc can be an arc between the electrode (e.g., electrode 1618, a plasma electrode) and the workpiece. A wire arc can be initiated (1710) between a wire element and the workpiece. A wire arc, in various embodiments, can function as required for a MIG process. Material can be added (1712) to the workpiece while the dual plasma torch traverses the workpiece in an additive manufacturing process.

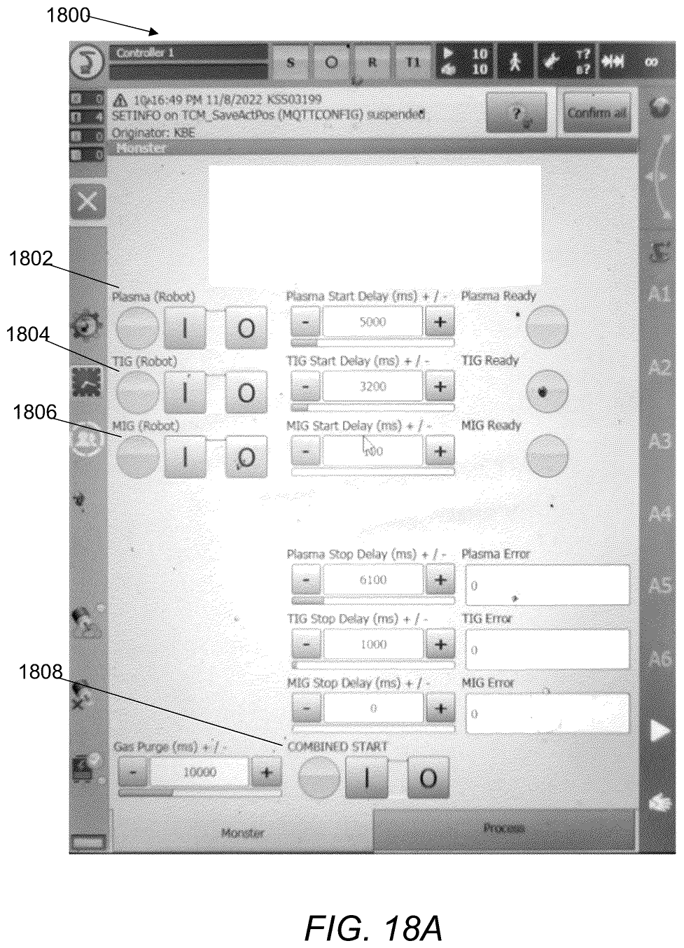

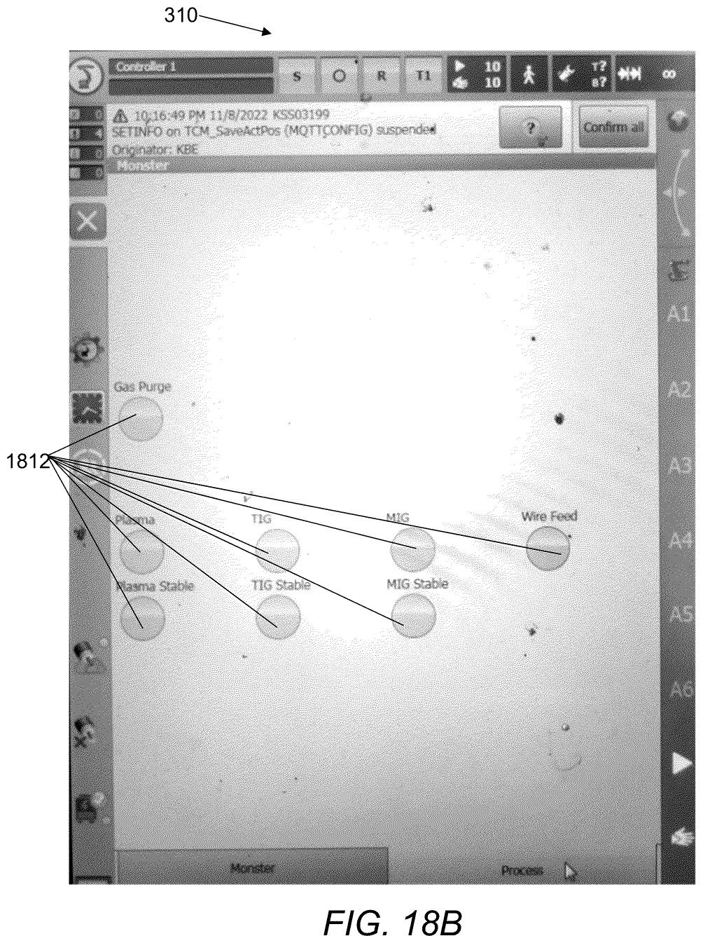

In various embodiments, a dual plasma additive manufacturing process can be controlled via a user interface. An example user interface for controlling a dual plasma additive manufacturing process is conceptually illustrated in FIG. 18A-18B. An interface 1800 can include controls for controlling an additive manufacturing process, a robotic additive manufacturing process, an additive manufacturing robot, and/or a dual-plasma torch. The interface 1800 can have controls for activating different power systems and/or arcs. A first arc can be controlled by a first set of controls 1802. A second arc can be controlled by a second set of controls 1804. A third arc can be controlled by a third set of controls 1806. A fourth set of controls 1808 can control the first, second, and third arc. In accordance with some embodiments, one or more sets (e.g., one set, or two sets, or three sets, or four sets, or all of the sets) can include on/off buttons, status indicators (e.g., indicating the status of associated systems), and/or a delay start input. Delayed start input can correspond to an amount of time the system will wait before initiating an arc. The interface 1800 can further include error indicators for each of the systems associated with the first arc, second arc, and/or the third arc.

In some embodiments the first arc can correspond to a pilot arc. The second arc can correspond to an assisting plasma arc. The third arc can correspond to the feed wire arc. The pilot arc can be an arc between an electrode and an outer body of a torch. The second arc can be an arc between an electrode and a workpiece. The first and second arcs can use the same electrode. The third arc can be formed between the workpiece and a feed wire arc.

The interface 1810 includes various indicators 1812. The indicators 1812 can show the status of various components and/or power supplies. In various embodiments, an interface can allow a user to control arc settings. Arc settings can include amperage, voltage and/or gas flow rate.

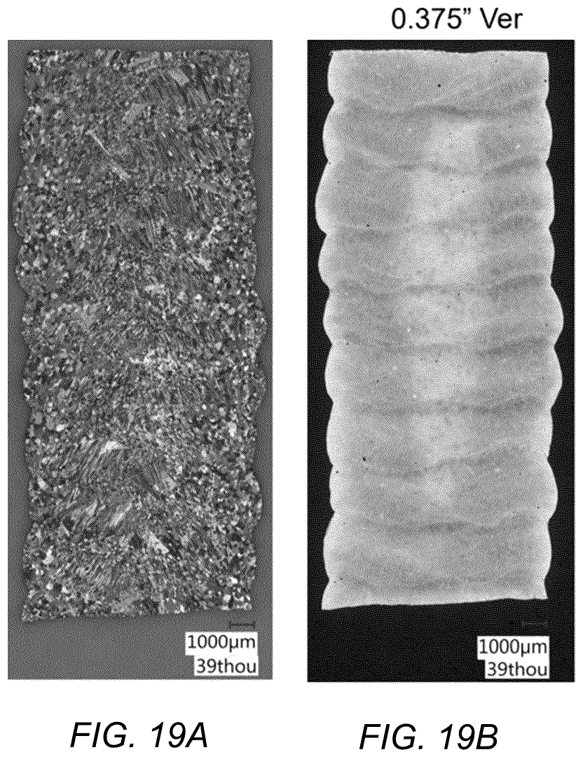

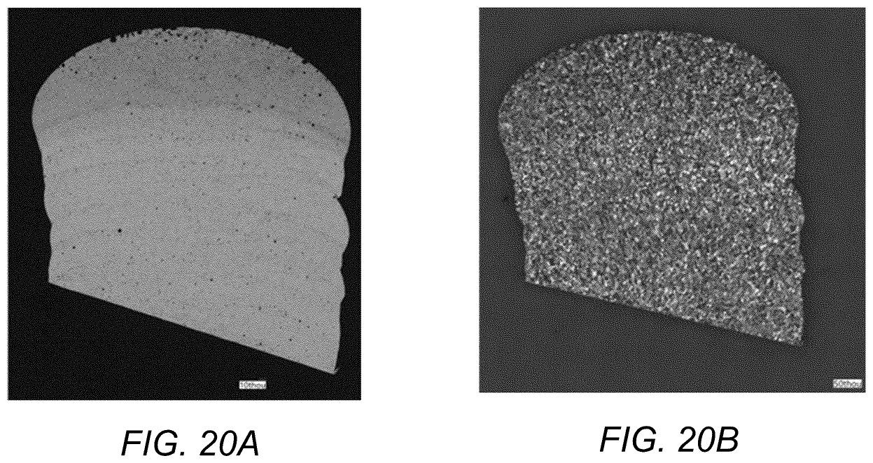

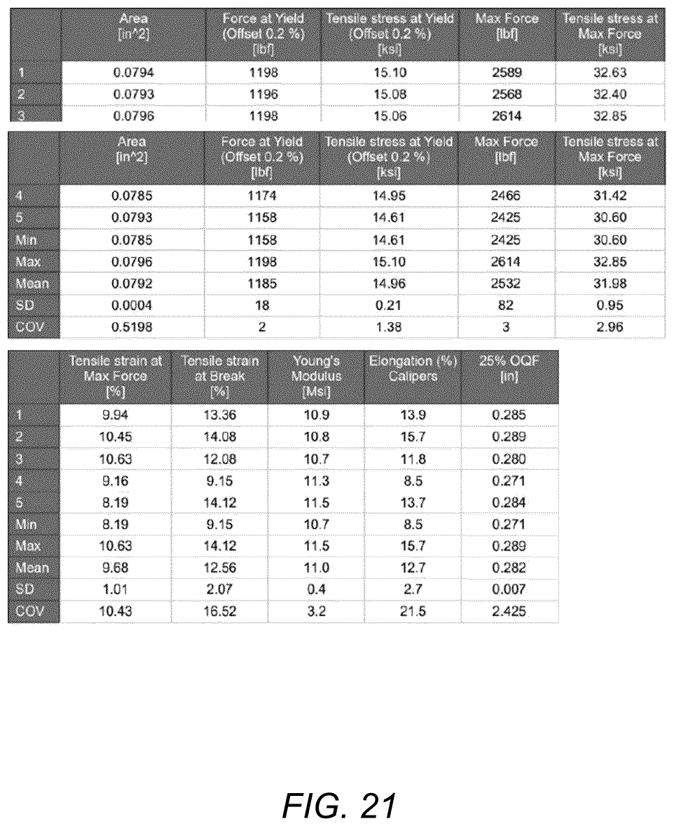

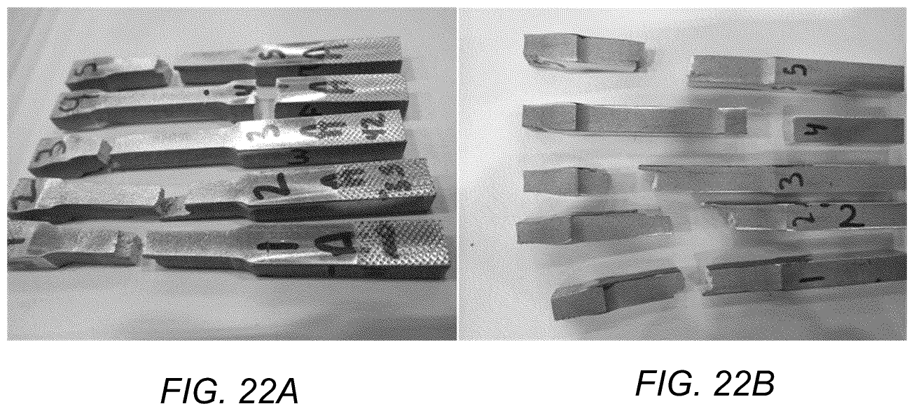

Dual plasma additive manufacturing can form desired grain structures for the printed parts. In various embodiments, dual plasma WAAM processes can result in a wider cooler temperature profile for a printed part compared to a similar non-dual plasma WAAM process. This temperature profile can be beneficial with respect to the grain structures that are formed during the manufacturing process. The grain structures of a printed part using a dual plasma additive manufacturing process in accordance with an embodiment are shown in FIGS. 19A-19B. FIGS. 20A-20B depict the grain structures of another printed part using a dual plasma additive manufacturing process in accordance with an embodiment. FIG. 21 depicts example sample data obtained based on testing samples manufactured using dual plasma WAAM process as described herein. FIGS. 22A-22B depict example tested samples manufactured using dual plasma WAAM process as described herein.

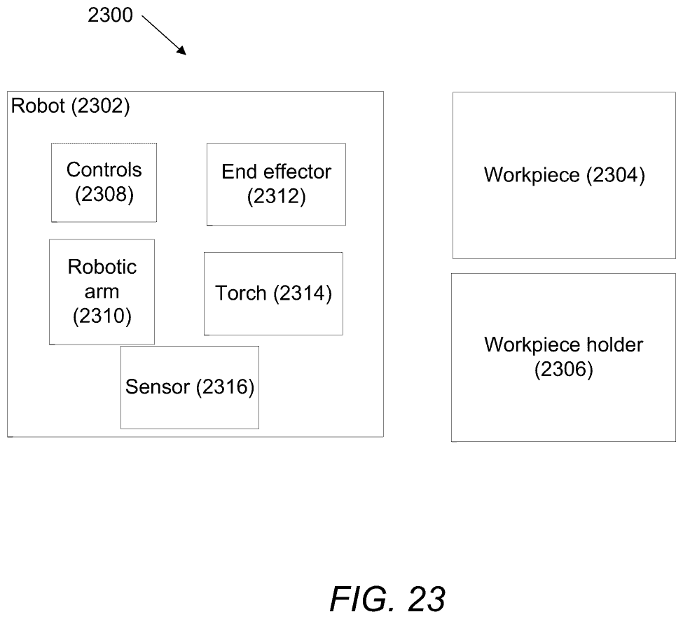

Dual plasma WAAM applicators (e.g., dual plasma torch) can be integrated into a robotic WAAM manufacturing system. An example robotic WAAM manufacturing system is conceptually illustrated in FIG. 23. A robotic WAAM manufacturing system 2300 can include a robot 2302, a workpiece 2304, and a workpiece holder 2306. The workpiece 2304 can be coupled (e.g., mechanically and/or electrically) to the workpiece holder 2306. The workpiece holder 2306 can be configured to move the workpiece 2304.

The robot 2302 can include controls (or controllers; or control units) 2308, robotic arms 2310, end effectors 2312, and/or torches 2314. The controls 2308 can provide commands to the robotic arms 2310, the end effectors 2312, the torches 2314 and/or the sensors 2316. The controls 2308 can include processor, memory, and input/output means. The end effector(s) 2312 can be mounted to a distal end of the robotic arm(s) 2310. The torch(es) 2314 can be mounted to the end effector(s) 2312 and/or the robotic arm(s) 2310. The controls 2308 can receive sensor input from one or more sensors 2316. The sensors 2316 can sense print quality, such as detecting defects, sending anomalies during printing. The sensors 2316 can measure print parameters and/or take visual images or videos to monitor the printing process. The sensors 2316 can be current sensors, voltage sensors, temperature sensors, cameras, The torch 2314 can be a dual-plasma torch as described elsewhere herein. In accordance with various embodiments of the invention, the controls can generate commands capable of causing robotic arms, end effectors, and/or torch assembly to perform actions. The controls can execute executable code.

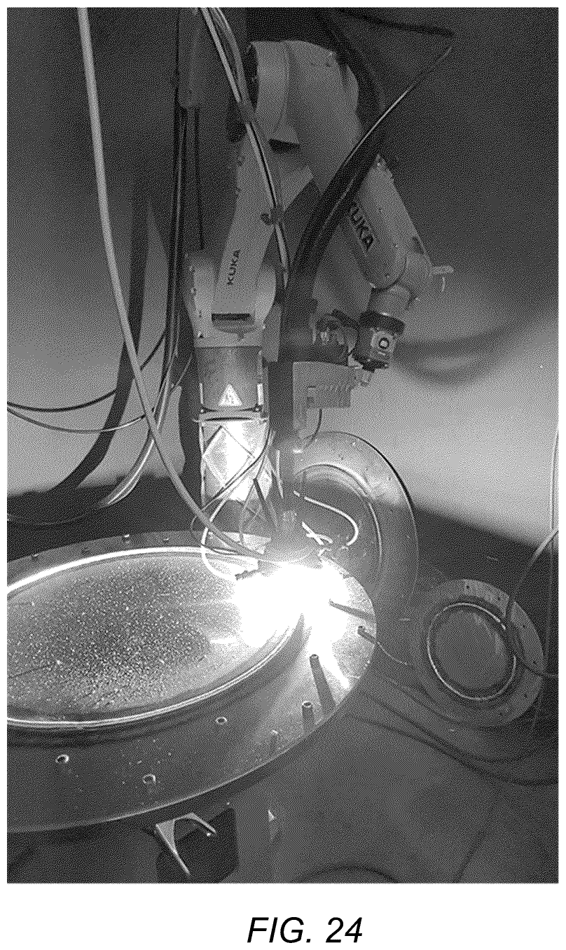

A picture of an example robotic WAAM manufacturing system incorporating a dual plasma torch is included in FIG. 24.

### Dual Plasma Multi-Wire Wire Arc Additive Manufacturing

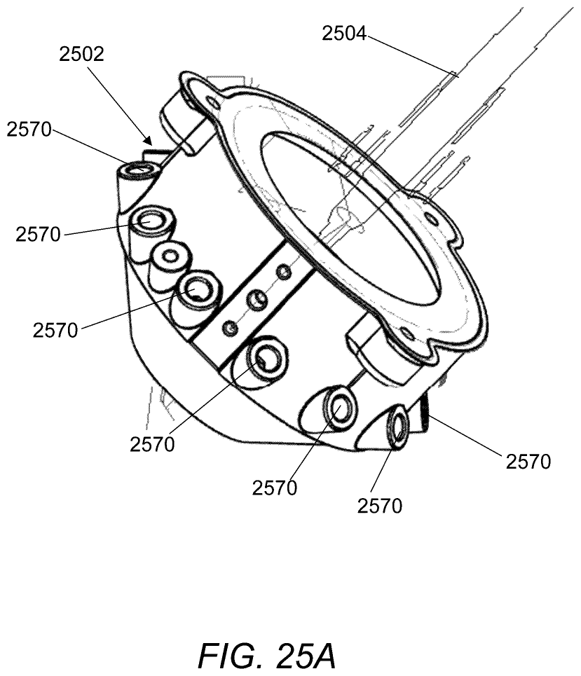

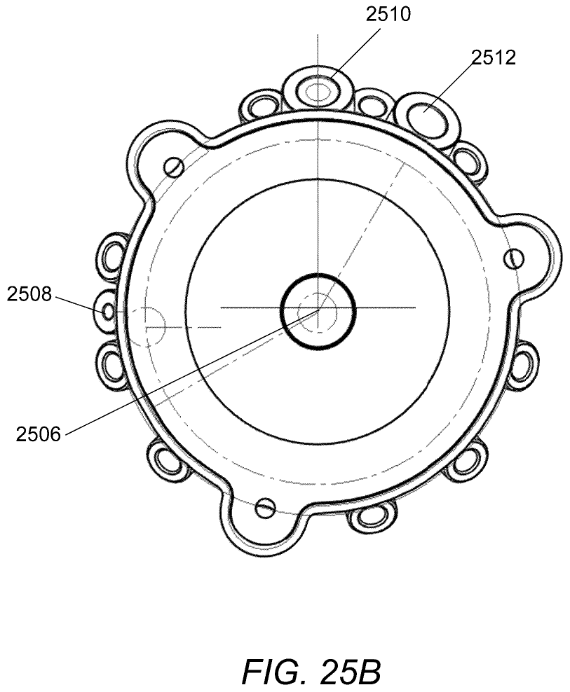

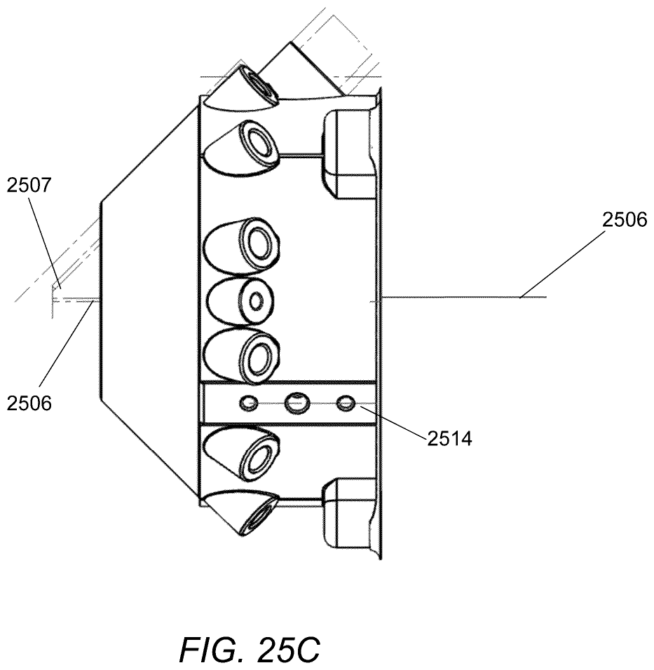

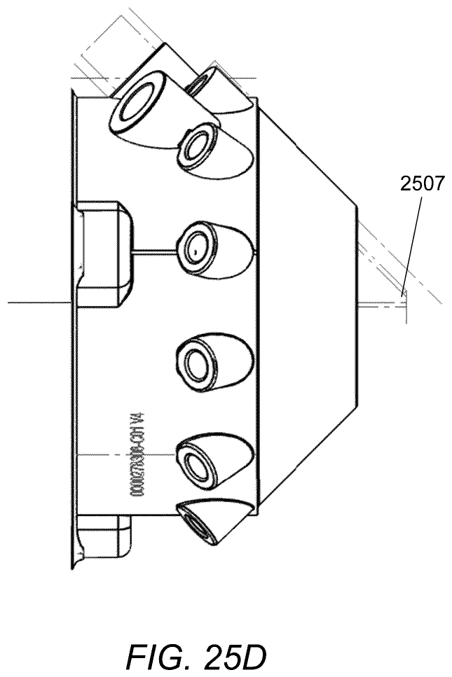

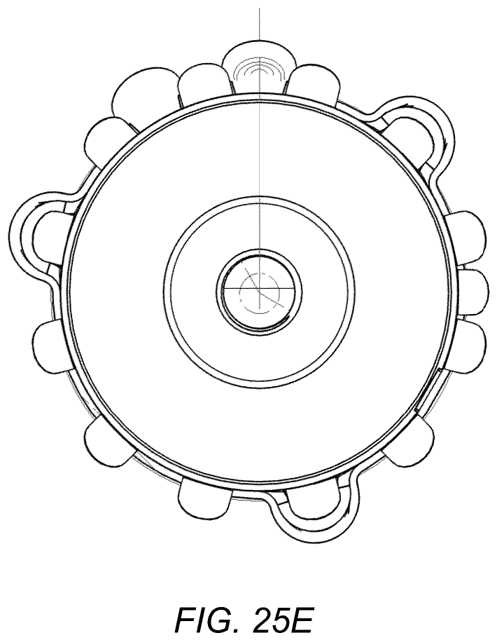

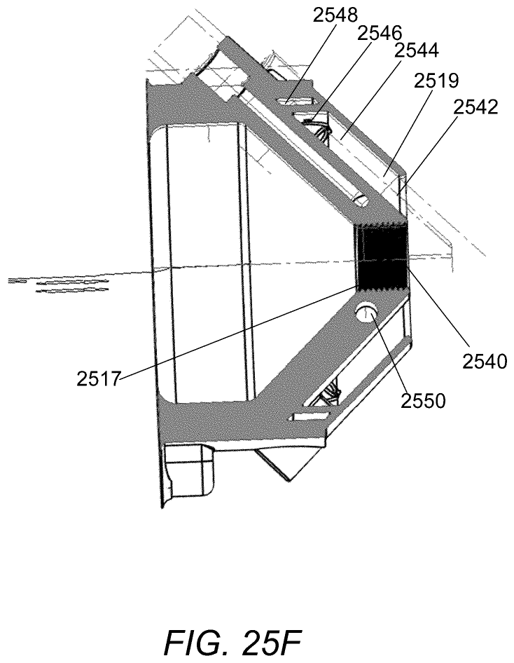

In accordance with several embodiments of the invention, a wire arc additive manufacturing applicator can include a dual plasma aspect (e.g., a dual plasma torch) with one or more ports for receiving one or more cold wires. The dual plasma aspect (e.g., dual plasma torch) can be similar in various aspects to the dual plasma systems described elsewhere herein. An outer body for a dual plasma torch with cold-wire ports is conceptually illustrated in FIGS. 25A-25F. The other components of a dual plasma torch with cold-wire ports can be similar in various ways to the dual plasma torches described elsewhere herein.

An outer body 2502 can be similar in various aspects to one or more outer bodies described and illustrated elsewhere herein. The outer body 2502 can be configured such that the outer body 2502 is suitable for dual plasma WAAM applications. Outer body 2502 is further configured to be capable of receiving a number of (e.g., from 0 to 12) cold wires through cold-wire ports 2670. The outer body 2502 can have 12 cold-wire ports 2570 disposed circumferentially. Some embodiments implement dual plasma torches with less than 12 cold wire ports in the outer body. Some embodiments implement dual plasma torches with more than 12 cold wire ports in the outer body.

The cold wire ports 2570 can be oriented at an angle relative to a hot wire torch. The hot wire torch can be disposed centrally with respect to the outer body 2502 such that the hot wire torch 2504 generally aligns with a central axis 2506. An angle 2507 between the cold wire ports 2570 and the hot wire torch 2504 can be around 42 degrees. In some embodiments, the angle 2507 can be greater than about 42 degrees. In some embodiments, the angle 2507 can be less than about 42 degrees. In various embodiments cold-wire ports are evenly distributed around the circumference of an outer body. Many embodiments can include outer bodies with various numbers of cold wire ports, for instance 1, 2, 3, 4, 5, 6, 7, 8, 9, 10, 11, 12 or another number of cold wire ports. The cold wire ports 2570 can include an outer portion 2572 and an inner portion 2574. The cold wire ports 2570 can be oriented such that a central axis of the cold wire ports 2570 is aligned to pass through a shielding gas channel 2544 and intersect with the central axis 2506 to form the angle 2507.

The outer body 2502 can include a gas port 2508 (e.g., for shielding gas), a coolant port 2510, and/or a coolant port 2512. Gas and coolant ports can be from the set of an inlet and/or an outlet. The outer body 2502 can have a grounding connection 2514. The outer body has an insert mounted to an inner opening 2517. The inner opening can be a circular exit for the assisting plasma. The outer body 2502 can have an outer opening 2519. The outer opening 2519 can be a circular (or annular) exit for shielding gas. In various embodiments, a coolant inlet, a coolant outlet, a gas port, and/or a grounding connection can be circumferentially disposed on an outer body. Inserts can be made from electrically insulating materials (e.g., ceramic). Inserts can be replaceable consumables. Inserts can be useful to prevent a wire (e.g., an aluminum wire) being used as an electrode during a welding process, and/or to prevent a wire from bonding with an opening of an outer body.

The outer body 2502 can have a plasma aperture 2540 and a shielding gas aperture 2542. In various embodiments the shielding gas aperture is communicatively coupled to a shielding gas supply. The shielding gas aperture 2542 can be at a terminal end of a shielding gas channel 2544. The shielding gas channel 2544 can be supplied with shielding gas through circumferentially arranged diffusing holes 2546. The diffusing holes can receive shielding gas from a circumferential shielding gas supply channel 2548. The outer body 2502 can include a cooling channel 2550. The cooling channel can be positioned circumferentially relative to the aperture 2540. In several embodiments, the aperture can be a bottom opening. The cooling channel 2550 can receive a coolant through an inlet channel and lose coolant through an outlet channel. In several embodiments the aperture 2540 can be threaded. Apertures (e.g., aperture 2540) can be positioned such that a hot wire electrode can extend up to, into, and/or through such apertures.

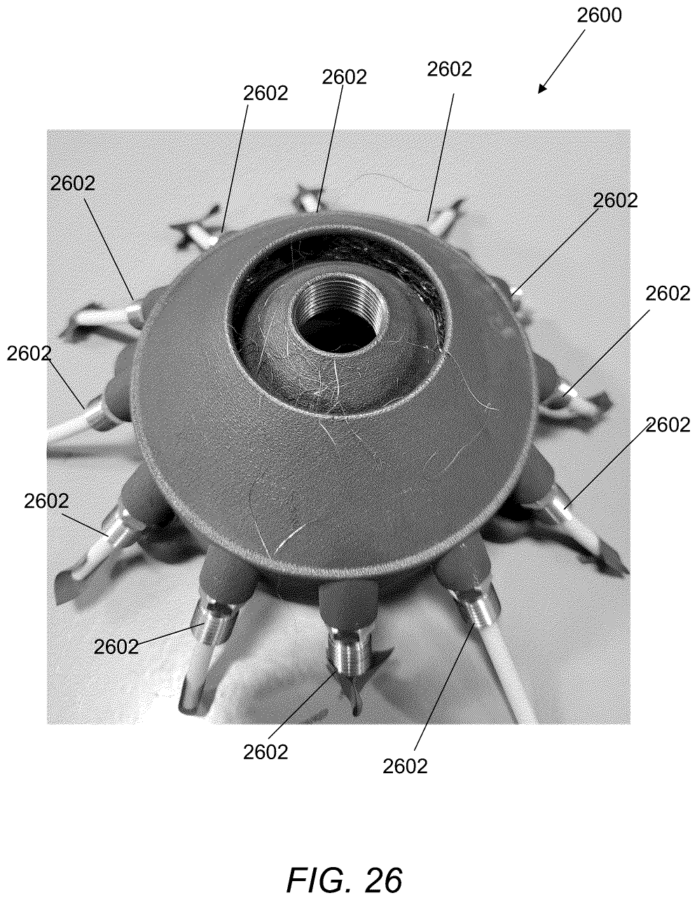

As shown in FIG. 26, dual plasma nozzles can be configured to feed up to twelve cold wires through cold wire ports. The dual plasma nozzle 2600 can have twelve cold wire ports 2602. Cold wire ports can be arranged circumferentially around a dual plasma nozzle. Dual plasma nozzles, as discussed in greater detail elsewhere herein, can include a central hot wire port for receiving and/or feeding forward a hot wire.

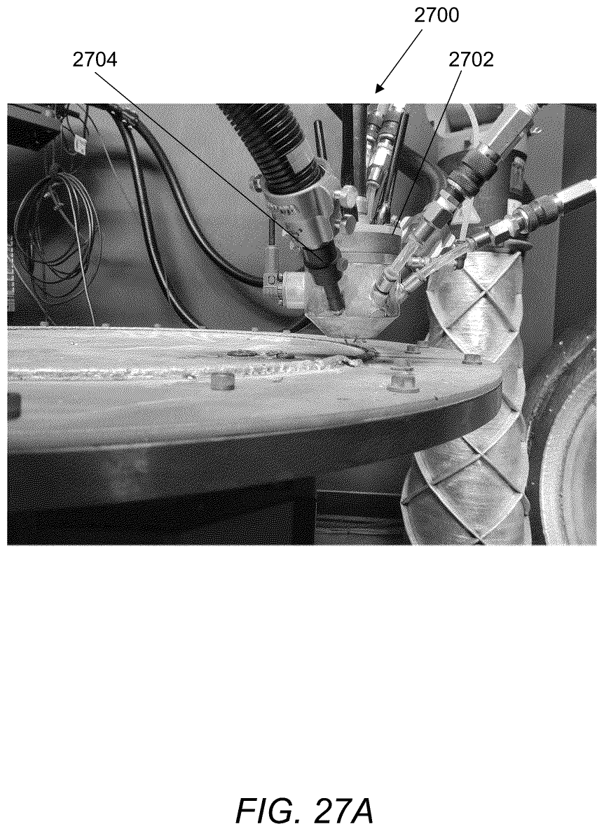

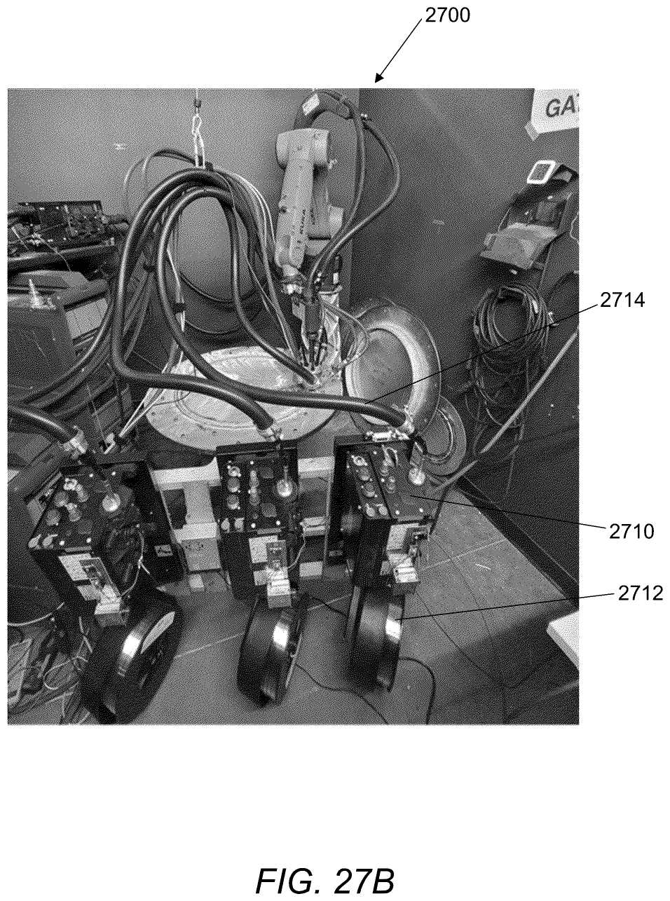

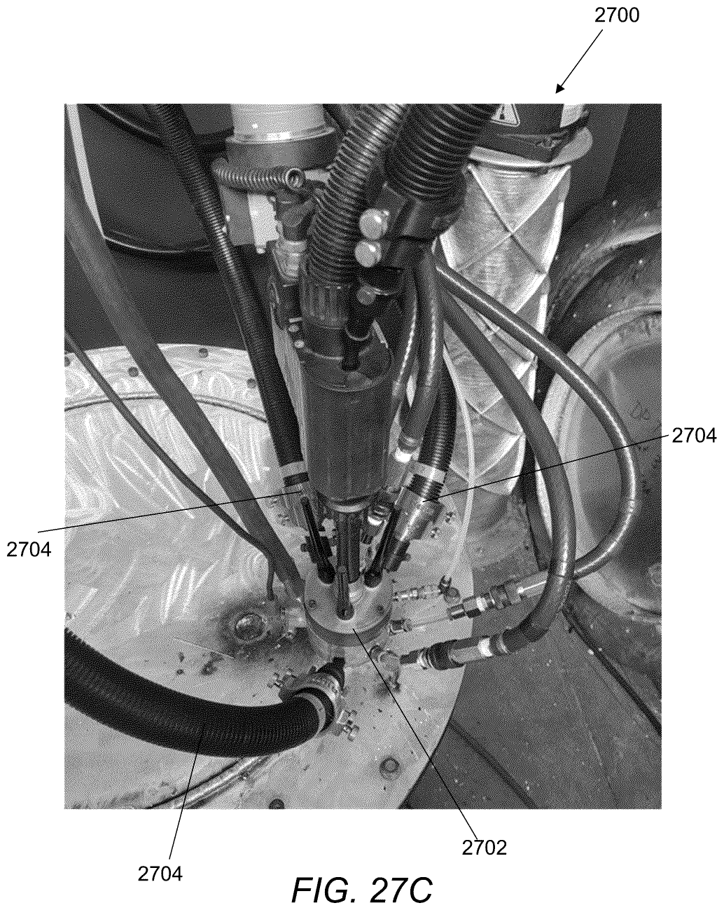

Dual plasma multi-wire WAAM manufacturing systems can have various similarities to systems described above (e.g., multi-wire systems and/or dual plasma systems). FIG. 27A through 27C depict an example of a dual plasma multi-wire WAAM manufacturing system. A dual plasma multi-wire WAAM manufacturing system 2700 can include a dual plasma torch 2702. In several embodiments, the dual plasma torch can include an outer body (e.g., an outer body similar to outer body 2702). The dual plasma torch 2702 can receive one or more cold wire systems 2704. In the depicted example, 3 cold wire systems are coupled to the dual plasma torch 2702. However, it is understood that any number (e.g., 12) of cold wire systems could be coupled to a dual plasma torch in a similar manner. Each of the cold wire systems 2704 can advance cold wires through the dual plasma torch 2702. When dual plasma multi-wire WAAM manufacturing systems are performing WAAM, cold wires can be advanced into a weld pool. In accordance with many embodiments of the invention, dual plasma torches can be configured to receive any number of cold wires. Cold wire ports can be arranged circumferentially relative to a hot wire torch. A hot wire torch can be disposed centrally with respect to a dual plasma torch. As shown in FIG. 27B, each of the cold wire systems 2704 can include a motor and control module 2710, a wire spool 2712, and an umbilical connector 2714.

In accordance with many embodiments, one or more cold wires can be used in a dual plasma nozzle. In several embodiments, deposition rates can be increased by adding one or more cold wires to a dual plasma WAAM torch. When adding one or more cold wires to a MIG torch assembly used for WAAM, porosity can increase to an unacceptable level and such porosity would not be observed when implementing the hot wire alone. The inventors surprisingly discovered that porosity levels can, in some embodiments, be simultaneously kept acceptably low, even with the addition of multiple cold wires when the hot wire and cold wires(s) are implemented with a dual plasma WAAM torch.

In many embodiments, a number (e.g., 3) of additional cold wires can be included in a dual plasma WAAM process. In some embodiments, each of the cold wires can be run at 50% feed rate of the main (hot) wire. In several embodiments, when combined, a hot wire and two cold wires in combination can achieve a deposition rate of around 25 pounds per hour with aluminum wire (e.g., aluminum wire as described in U.S. patent application Ser. No. 17/929,558 and/or U.S. patent application Ser. No. 18/478,703, both incorporated by reference above). In some embodiments, three cold wires combined with a hot wire can achieve a deposition rate of around 30 pounds per hour with aluminum wire (e.g., the wires described the applications incorporated by reference above). This can be compared with single hot wire deposition rates of around 3.9 pounds per hour to around a maximum of 6.3 pounds per hour. Again, adding cold wires can, in several embodiments, improve deposition rates surprisingly without significant degradation of defect levels.

In several embodiments cold wire systems can be capable of selectively advancing cold wires. For instance, the directional configuration of the print head can provide the ability to load wires in any number of the ports and/or selectively activate wires in the direction of travel. This can be beneficial to allow the print head to follow the geometry of the part without having to stop and do a major reconfiguration.

In several embodiments cold wires used in a dual plasma torch can be of various compositions. The composition of each cold wire can be different from each other cold wire and/or different from the composition of the hot wire. In this way each wire advanced into the weld pool could have a different composition or some wires may have the same composition while one or more other wires have a different composition. In several embodiments the cold wire(s) and/or hot wire have different compositions such that custom alloys can be generated in-situ during a WAAM process.

In multi-wire dual plasma WAAM process, the cold wire(s) can be positioned so that the auxiliary plasma (e.g., plasma column) can provide pre-heating of the cold wire(s) before the cold wire(s) goes (or go) into the main arc. In many embodiments, the amount of preheating of the cold wire can depend on the angle of the cold wire relative to the hot wire. In several embodiments, cold wires can be at an angle between parallel and perpendicular to the hot wire.

In several embodiments, as the cold wire is oriented more parallel to the main wire, the more the cold wire will be subjected to pre-heating by the auxiliary plasma. In this way, the angle at which the cold wires are coming into the weld pool is significant. In several embodiments, the cold wire ports of a dual plasma nozzle are configured such that cold wires advanced through the cold wire ports can enter the dual plasma nozzle at an angle of 42 degrees.

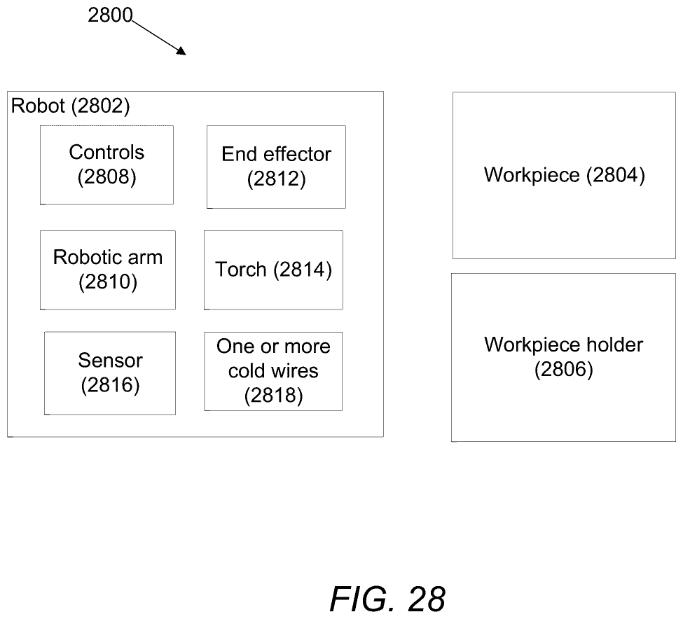

Dual plasma multi-wire WAAM manufacturing systems (e.g., dual plasma torch with multi-wire compatibility) can be integrated into a robotic WAAM manufacturing system. An example robotic WAAM manufacturing system is conceptually illustrated in FIG. 28. A robotic WAAM manufacturing system 2800 can include a robot 2802, a workpiece 2804, and a workpiece holder 2806. In several embodiments, the workpiece 2804 can be coupled (e.g., mechanically and/or electrically) to the workpiece holder 2806. The workpiece holder 2806 can be configured to move the workpiece 2804.

The robot 2802 can include controls 2808, robotic arm 2810, end effector 2812, a torch 2814, one or more sensors 2816, and/or one or more cold wires systems 2818. The controls 2808 can provide commands to the robotic arm 2810, the end effector 2812, a torch 2814, sensor 2816, and/or one or more cold wire systems 2818. Cold wire systems, in several embodiments can include a cold wire capable of being advanced by an actuator through a cold wire port. The controls 2808 can include processor, memory, and input/output means. The end effector 2812 can be mounted to a distal end of the robotic arm 2810. The torch 2814 can be mounted to the end effector 2812 and/or the robotic arm 2810. The controls 2808 can receive sensor input from one or more sensors 2816. The torch 2814 can be a dual-plasma torch as described elsewhere herein. In accordance with various embodiments of the invention, controls can be capable of generating commands, the commands capable of causing robotic arms, end effectors, and/or torch assembly to perform actions. The controls can execute executable code.

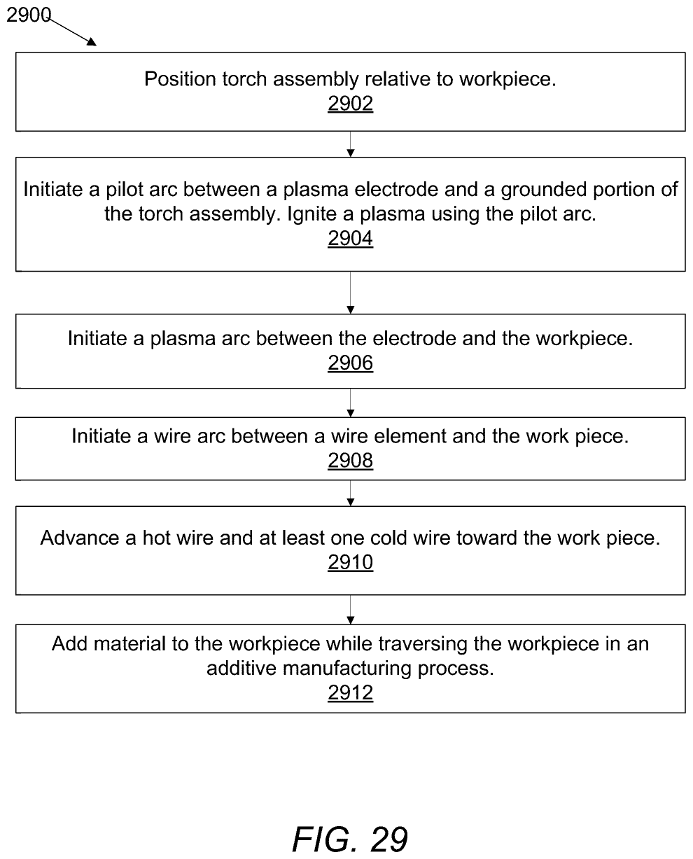

In various embodiments, a manufacturing process can include performing additive manufacturing (e.g., WAAM) using a dual plasma torch aspect with cold wire and hot wires used for material deposition. Such manufacturing can be known as dual plasma multi-wire arc additive manufacturing. An example process for multi-wire additive manufacturing using a dual plasma torch is conceptually illustrated in FIG. 29. The additive manufacturing process 2900 can be a WAAM process. A torch assembly can be positioned (2902) relative to a work piece. A pilot arc can be initiated (2904). The pilot arc can be an arc between an electrode and a grounded portion of a torch assembly (e.g., an outer body portion). In some embodiments, the plasma ignition arc can ignite a plasma. A plasma arc can be initiated (2906) between the electrode and the workpiece. The plasma arc can facilitate a plasma stream to the workpiece. In some embodiments, initiating the plasma arc can coincide with the dissipation of the pilot arc. The pilot arc can be rapidly disconnected when the pilot arc is established, for example, substantially simultaneously with igniting the pilot arc. The plasma arc can be an arc between the electrode (e.g., a plasma electrode) and the workpiece. A wire arc can be initiated (2908) between a wire element and the workpiece.

A wire arc, in various embodiments, can function as required for a MIG process. A hot wire (e.g., hot wire used with the wire arc) and one or more cold wires can be advanced (2910) toward the work piece. Cold wires can be advanced through cold wire ports. Each cold wire port can have a cold wire advanced through it. The cold wire port can function to control the angle at which the cold wire leaves an outer body (e.g., an outer body 2502). Material can be added (2912) to the workpiece while the dual plasma torch traverses the workpiece in an additive manufacturing process. The material can be supplied by both the hot wire and the one or more cold wires.

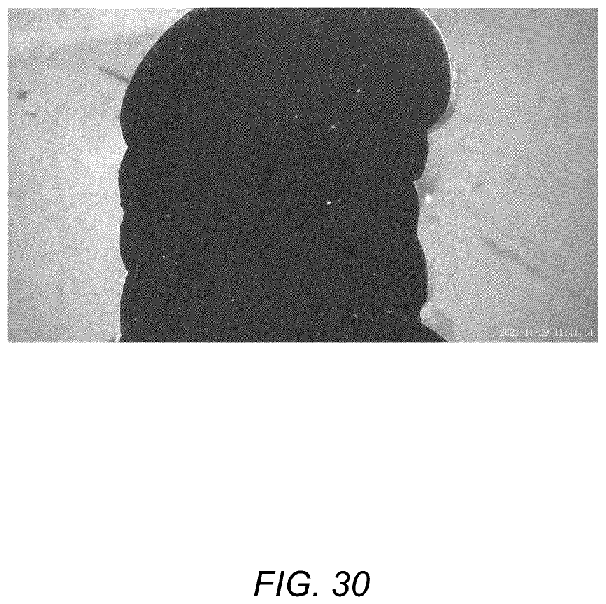

Dual plasma additive manufacturing can have benefits with respect to a grain structure and/or porosity of a printed part. In various embodiments, as noted above, dual plasma multi-wire WAAM processes can surprisingly deposit material with low porosity. An example cross-section of material added using a dual plasma multi-wire additive manufacturing process is shown in FIG. 30.

While specific assemblies, components and/or systems for a dual plasma torch are described above, any of a variety of assemblies, components and/or systems can be utilized as a dual plasma torch as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to a dual plasma torch, the techniques disclosed herein may be used in any type of additive manufacturing process. The techniques disclosed herein may be used within any of the additive manufacturing assemblies, components, systems, methods and/or processes as described herein.

### Plasma Arc Surface Smoothing

Many embodiments implement plasma arc surface smoothing to remove parasitic mass and/or cold lap as a finishing step for manufactured (e.g., additively manufactured) parts. This can be beneficial to improve a part's surface finish and to reduce incidence of cracking associated with cold lap. In several embodiments plasma arc surface smoothing can be beneficial to reduce and/or replace machining and/or laser cleaning.

In this specification, the term “parasitic mass” can refer to the mass of a structure that results from the bulk roughness of the structure's surface and does not contribute to the structural capability of the structure. For example, the parasitic mass of a rocket tank does not contribute to the tank's strength. A rocket tank with low or no parasitic mass but having the same overall mass as a rocket tank with greater parasitic mass may have greater strength per unit mass.

In several embodiments a TIG arc can be used to perform surface finishing. Some embodiments can use a TIG torch to perform the surface smoothing processes. As can be readily appreciated, any of a variety of TIG torches can be utilized as appropriate to the requirements of specific applications in accordance with various embodiments of the invention. Some embodiments can use a dual plasma torch for performing the processes. A dual plasma torch can be one described in FIGS. 16A-16H. As can be readily appreciated, any of a variety of a dual plasma torch can be utilized as appropriate to the requirements of specific applications in accordance with various embodiments of the invention. Implementing surface smoothing methods using a dual plasma torch can be advantageous for performing surface finishing steps without needing to switch the end effector. The term “dual plasma” refers to the torch that incorporates at least two plasma arcs, such as a MIG arc and a TIG arc. Nevertheless, the term “dual” in this disclosure should not be understood to be limited to “two” and that a “dual” plasma process may encompass more than two plasma arcs in some embodiments.

When performing plasma arc surface smoothing processes, a plasma arc surface smoothing device can move along the outside of a printed filament. This process can smooth out the surface of an additively manufactured part. Plasma arc surface smoothing can remove parasitic mass of a rough surface (e.g., an additively printed surface) and/or can remove overlaps that can accumulate during a print. This surface treatment can typically be performed after a finished print. However, surface treatments, as discussed herein can be performed during a print process (e.g., before the print is complete, continuously, and/or without stopping the print). In several embodiments, a plasma torch assembly can be positioned by a robot such that the TIG torch position, during successive passes, results in overlapping treatment areas. During plasma arc surface smoothing, a torch control system can maintain a MIG plasma arc inactive while the TIG plasma arc is active. The TIG torch can be an independent TIG torch or a TIG torch component of a dual plasma torch. The MIG torch can be an independent MIG torch or a MIG torch component of a dual plasma torch.

In a plasma arc surface smoothing process, the plasma can work to spot melt the printed material. Spot melting the printed material can be implemented as part of a plasma arc surface smoothing process and can result in a shiny, finished material without adding, removing, and/or machining any material while retaining the integrity of the structure. The mass of the printed and treated part can stay the same. In various embodiments, parasitic mass can be melted and converted into non-parasitic mass. In accordance with embodiments of the invention, substantially no, or in some embodiments no, material falls off or is added. The plasma arc can smooth the surface, which can be beneficial for removing cold lap and/or reducing cold lap associated cracking. Beneficially, plasma arc surface smoothing can be performed using a dual plasma torch that is suitable for depositing material in an additive manufacturing process. In at least one embodiment, the additive manufacturing process comprises using at least two plasma arcs, such as a MIG arc and a TIG arc, simultaneously and/or substantially simultaneously, and the smoothing process comprises using at least one plasma arc, such as a TIG arc. In this way, the same end effector (e.g., torch) can be used for deposition (or printing) and post-deposition processing (such as, but not limited to, surface smoothing). Therefore, an additive manufacturing process can include depositing weld material, stopping deposition, conducting plasma arc surface smoothing, and starting depositing again, all using the same torch by turning the MIG wire in the torch on and off.

Many embodiments implement various types of print heads for printing during additive manufacturing processes (such as WAAM processes) and/or surface smoothing. Some embodiments implement a dual plasma torch assembly for printing and/or surface smoothing. During WAAM printing processes, feed wires (one wire or multiple wires) can be fed through a torch assembly (such as through a MIG torch component as shown in FIG. 16A-16H). Electric energy (supplied by a power source) can create an electric arc to melt the feed wires such that the molten feed wires can be deposited on a substrate (or a previously printed layer) of the print part. The electric arc can be created from the MIG torch via the feed wire. During printing, a first shielding gas can be applied to surround the wire and/or the substrate and shield the molten wire and/or the weld pool from contaminants in the environment. The dual plasma torch assembly can have a plasma channel (such as a TIG torch component) to accommodate a second shielding gas. Electric energy (a voltage or a current) applied to an electrode (such as a tungsten electrode of a TIG torch component) can ionize the gas and form a plasma arc as additional shielding to the feed wires and/or the substrate. The plasma arc can surround the electric arc. During surface smoothing processes, feed wires are not in use or the feed wires can be turned off. Some embodiments can turn off the feed wire(s) in the MIG torches by using software control. Electric energy (such as a current or a voltage) can be applied through the TIG torch component to the surface of the print part. The shielding gas and the electrode (such as the tungsten electrode of the TIG torch component) can create a plasma arc to shield the molten material during surface smoothing processes. The plasma arc can melt (such as spot melt) the materials and remove any undesired parasitic mass and smooth the surface while shielding the processes. Surface smoothing in accordance with many embodiments can take place after the printing is complete or during a print. In certain embodiments, printing can be resumed after surface smoothing by turning on the wire in the dual plasma torch assembly (such as the MIG torch component). In certain embodiments, printing can be resumed after surface smoothing by turning on the wire in the dual plasma torch assembly (such as the MIG torch component).

In some embodiments, the MIG torch component and the TIG torch component(s) of the dual plasma torch assembly can be implemented simultaneously and/or substantially simultaneously during the printing processes. Using the MIG torch component and the TIG torch component(s) can provide at least two plasma arcs during printing to accelerate the printing processes. During the surface smoothing processes, the MIG torch component is turned off and the TIG torch component(s) can be used for smoothing. Turning off the MIG torch components of the dual plasma torch assembly can be achieved using software control without changing hardware.

In some embodiments, the MIG torch component of the dual plasma torch assembly can be implemented for printing. During the surface smoothing processes, the MIG torch component is turned off and the TIG torch component(s) of the dual plasma torch assembly can be used for smoothing. The switching between the MIG torch components and the TIG torch components of the dual plasma torch assembly can be achieved using software control without changing hardware.

Using the same torch assembly for printing and surface smoothing can eliminate the need to change the end effector tools such that the print time can be shortened, the print process can be simplified, and the print qualities can be improved. The plasma arcs can spot melt the printed material to achieve a shiny, finished material without adding or removing/machining any material of the print part. The surface smoothing processes can retain the integrity of the structure. The mass of the printed and treated part stays the same. No material falls off or is added. Surface smoothing can remove cold lap and the cracking associated.

Some embodiments use independent MIG torches for printing and independent TIG torches for surface smoothing. In such embodiments, tool change at the end effector will be implemented between the printing and the surface smoothing processes. The MIG torches attached at the end effector can deposit the feed wires to a substrate or a previously deposited layer of material to form a print part. When printing is complete, the TIG torches can be switched to the end effector to smooth the surface of the print part.

In several embodiments, a plasma arc surface smoothing device can smooth out at least about two inches in a pass. To achieve this, a process can use weaving. Some embodiments can perform surface smoothing at a rate of about 70 inches an hour. In some embodiments, travel speed can be increased with amperage. In accordance with embodiments of the invention, weaving can beneficially limit heat penetration and improve heat distribution. An even heat distribution can be desirable. When plasma arc surface smoothing is used with weaving, the process can go back over a treatment area multiple times and slowly melt it. Weaving can refer to a positioning method wherein the plasma arc is moved from side to side (e.g., transversely) as the process is performed along a distance (e.g., length, circumference of a workpiece).

In various embodiments, plasma arc surface smoothing can be configured so that melt penetrates around 1 mm into a part. In accordance with many embodiments, process parameters can be configured to control melt penetration. It can be beneficial to treat a thin external surface of a printed part to achieve surface smoothing without excessively affecting the mechanical properties of the part.

A benefit of surface smoothing with dual plasma torch assembly is that it produces a very smooth surface without having to change the end effector (e.g., torch) for machining and/or other surface treatments. Furthermore, plasma arc surface smoothing can reduce and/or eliminate the need for part cleaning, such as wire brushing or laser cleaning. This can reduce the labor requirements associated with printing, because deposition, laser cleaning, and machining can often require separate tools, teams, and/or work locations in legacy systems.

Plasma arc surface smoothing can provide a smooth surface and/or cleaning action to additively manufactured parts. This is beneficial to replace laser cleaning and machining. Plasma arc surface smoothing can replace cleaning and/or machining operations in several embodiments. In various embodiments, plasma arc surface smoothing can be used in conjunction with laser cleaning. Laser cleaning can include cleaning the outside of the part each time the process will weld back over a portion of a part. Plasma arc surface smoothing offers another advantage since pieces of printed structure do not become airborne during various embodiments of plasma arc surface smoothing process. This beneficially improves operator safety (e.g., improved safety versus respiration hazard). A further benefit of using plasma arc surface smoothing is that no hardware changeouts are needed. Merely setting changes are required.

In accordance with various embodiments, a process can include: depositing material using a plasma arc torch assembly (e.g., MIG and TIG components of a dual plasma arc torch assembly); turning off MIG component(s) of the plasma arc torch assembly; using TIG component(s) to perform plasma arc surface smoothing. In several embodiments, a process can include: depositing material using a plasma arc torch assembly (e.g., MIG components of a dual plasma arc torch assembly); turning off MIG component(s) of the plasma arc torch assembly; using TIG component(s) to perform plasma arc surface smoothing. In many embodiments, a process can include: depositing material using MIG torches; switching out the MIG torches to TIG torches; using the TIG torches to perform plasma arc surface smoothing. In many embodiments, plasma arc surface smoothing performance can be characterized by a weaving pattern used, a power level used, a torch type used, a travel speed, and/or other parameters. Weaving patterns can be configured such that using the weaving pattern can gradually heat a surface of a manufactured article until it melts.

The inventors discovered that, when plasma arc surface smoothing is used, it can be important to have shallow heat penetration to avoid excessive changes to the mechanical properties of a printed material. In various embodiments, the amount of heat to a specific area can be controlled based on the power for the plasma arc surface smoothing, the travel rate of the plasma arc, and/or the travel pattern (e.g., weaving pattern).

In some embodiments, two plasma smoothing treatments are applied to areas of a printed material adjacent to each other, such that no unmelted material exists between the two treatments. Spacing can be controlled based on robot control of the plasma arc position in several embodiments. In accordance with many embodiments of the invention, weld parameters can be selected to determine how wide an area of printed material is melted during plasma arc surface smoothing. Shallow penetration can avoid causing structural issues in accordance with some embodiments. Shallow penetration during plasma arc surface smoothing can be beneficial to reduce incidence of hot cracking. In some embodiment, the thickness of the material melted can be less than or equal to around 1 mm from the outer surface. Hot cracking is a common risk when welding aluminum autogenously (not adding additional filler metal).

Weaving patterns can be determined based on a set of parameters. Various parameters can be adjusted including frequency, amplitude, right and left position, stopping time, weave angle, torch angle, etc. In several embodiment plasma arc surface smoothing uses one or more of various weave patterns. An example weave pattern is a “triangle weave” pattern. When performing plasma arc surface smoothing, in various embodiments, the plasma arc can be moved (e.g., by a robotic arm to which the plasma arc system is mounted) laterally across the part from a first side to a second side, and then along a longitudinal and/or circumferential direction.

In accordance with many embodiments of the invention, weave length (e.g., a lateral distance) can be very short (e.g., less than or equal to around 2 mm; or greater than or equal to around 2 mm). Weave length can represent how far the plasma arc end effector is moved longitudinally between lateral movements. With this approach, when each repeated shape in a wave pattern is repeated, the length of the weave can be sufficiently short such that the material gradually melts after repeated exposure to the plasma arc. The weave pattern can be configured such that the material is heated gradually to avoid digging into the treated material too much. Conceptually, this is similar to using a torch and going over a surface and then slowly moving the torch in a repeating pattern while traversing the material.

Surface treatments of plasma arc surface smoothing can be configured by controlling weave settings, amperage, and/or plasma arc travel speed. Weave settings can refer to the shape and/or size of the pattern about which a plasma arc may travel during plasma arc surface smoothing. The plasma arc travel speed can refer to a travel speed of a plasma arc torch. Plasma arc surface smoothing processes can be configured to control an amount of heat output. The amount of heat output during a plasma arc surface smoothing process can correspond to a surface, material, and/or item being processed.

Plasma arc surface smoothing can require hardware capable of handling a high level of heat (e.g., using around 100 Amperes of current; or less than around 100 Amperes of current; or greater than about 100 Amperes of current), for a long time (e.g., several hours or longer). Hardware for plasma arc surface smoothing can incorporate conformal cooling channels (e.g., internal cooling channels). Cooling channels can prevent a torch from overheating during a plasma arc surface smoothing process. Cooling channels can allow the plasma arc surface smoothing hardware to be used at amperages higher than 100 Amperes and/or for longer durations.

In accordance with many embodiments of the invention, the properties of a plasma arc can be dependent on the characteristics of one or more electrodes used in a plasma arc torch. In many embodiments, the characteristics of the one or more electrodes can include the electrode material (e.g., tungsten), the electrode diameter, and/or an electrode stick-out distance. Modifying the characteristics of the one or more electrode characteristics can modify the properties of a plasma arc.

In accordance with embodiments of the invention, the surface smoothing plasma arc for plasma arc surface smoothing can be located between a feed wire of a MIG torch and associated shielding gas. Surface smoothing plasma arc can be issued from an assisting plasma channel of a dual plasma torch assembly. Assisting plasma channels can have circular exits that are concentric with feed wires. The feed wire can be concentric with an exit of a shielding gas. The inside of the assisting plasma channel can be formed of two electrically isolated surfaces. An electrode side of the channel can be electrically connected with an electrode. An outer body side of the channel can opposite the electrode side. The outer body side can have an insulating coating on a first portion of the channel located distal relative to the electrode. The outer body side can have an uninsulated second portion of the channel located proximally relative to the electrode.

In various embodiments, the surface smoothing plasma can be directed through a circular exit. The circular exit can have an insert. The insert can be formed of ceramic. The insert can have a central through-hole. The insert can be a threaded part for easy removal and/or replacement. The insert can be made of a material that is non-wetting with the liquid (e.g., melted) form of the feed wire (e.g., can be a ceramic). This can make the system suitable for a large diameter feed wire (e.g., 2 mm, 2.4 mm, or another diameter). A large diameter wire feed can be greater than would be suitable for a similar system without a dual plasma aspect. The feed wire can, in various embodiments, pass through the insert. The surface smoothing plasma can be used in a dual plasma wire arc additive manufacturing process. The insert can, in various embodiments, protrude further towards a deposition site than the shielding gas channel exit. In several embodiments, the insert can be the closest part (e.g., not considering the feed wire) of the nozzle to the workpiece and/or deposition site.

In accordance with several embodiments of the invention, a wire arc additive manufacturing applicator can include a dual plasma aspect (e.g., a dual plasma torch). Such a device can be used to perform plasma arc surface smoothing as described herein. A first example dual plasma torch assembly is conceptually illustrated in FIGS. 16A-16H.

In several embodiments, the internal cooling channels and/or other internal structures can be realized using additive manufacturing techniques. In many embodiments the internal structures described herein (e.g., the cooling channels, the electrode receivers, torch receivers, fastener receivers, and/or other structures) can be manufactured using additive manufacturing processes. Inner bodies, outer bodies, and/or other components can be manufactured, in accordance with embodiments of the invention, using additive manufacturing. Additive manufacturing can be beneficial where the desired geometries are difficult to achieve through traditional manufacturing.

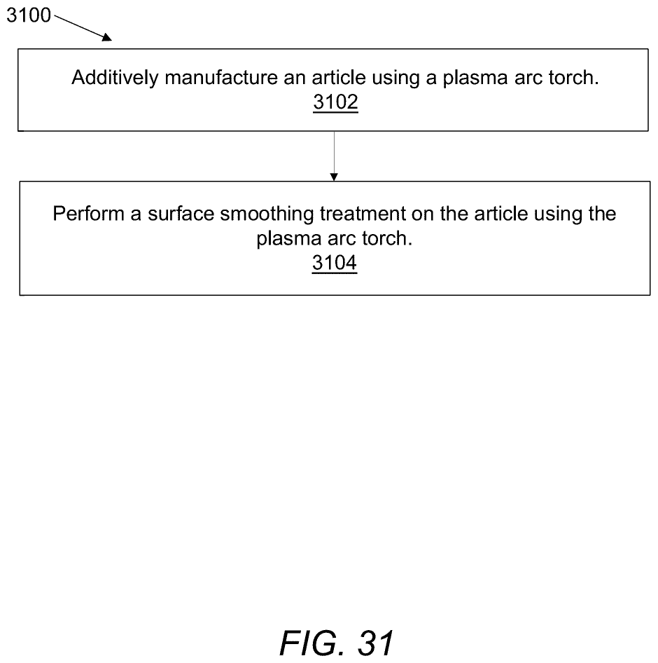

In various embodiments, a manufacturing process can include performing additive manufacturing (e.g., WAAM) using a dual plasma torch aspect. This manufacturing can be known as dual plasma wire arc additive manufacturing. An example process for additive manufacturing using a dual plasma torch is conceptually illustrated in FIG. 31. The additive manufacturing process 3100 can be a WAAM process with plasma arc surface smoothing. A plasma arc torch assembly can additively manufacture (3102) an article such as (but not limited to) using the MIG and TIG components of a plasma arc torch assembly, or using the MIG components of a plasma arc torch assembly. The plasma arc torch assembly can, in some embodiments, include a dual plasma torch as described elsewhere herein. The manufacture of an article including through use of dual plasma WAAM processes are described above. The plasma arc torch assembly can then be used to perform (3104) a plasma arc surface smoothing process on the article such as (but not limited to) using the TIG components of a plasma arc torch assembly. Performing a plasma arc surface smoothing process can include deactivating at least one plasma system in the plasma arc torch assembly. In at least one embodiment, performing the process comprises deactivating the MIG arc and using the TIG arc to melt the surface, so that no wire is deposited during the process. The process can further include a plasma arc being initiated between an electrode (e.g., a tungsten electrode) and the workpiece. The plasma arc can facilitate a plasma stream to the workpiece. This plasma stream can cause surface melting on the workpiece. Surface melting can be performed in conjunction with the various embodiments described herein. As the plasma stream causes surface melting, the torch assembly can weave to gradually melt a surface following a predetermined pattern. The weave can be defined by a lateral distance, a longitudinal distance, and/or a travel speed. In accordance with many embodiments, of the invention the weave can be configured such that on each pass the surface treatments overlap. The weave in conjunction with plasma arc surface melting can be performed until a surface is fully treated (e.g., until a plasma arc surface smoothing process is complete).

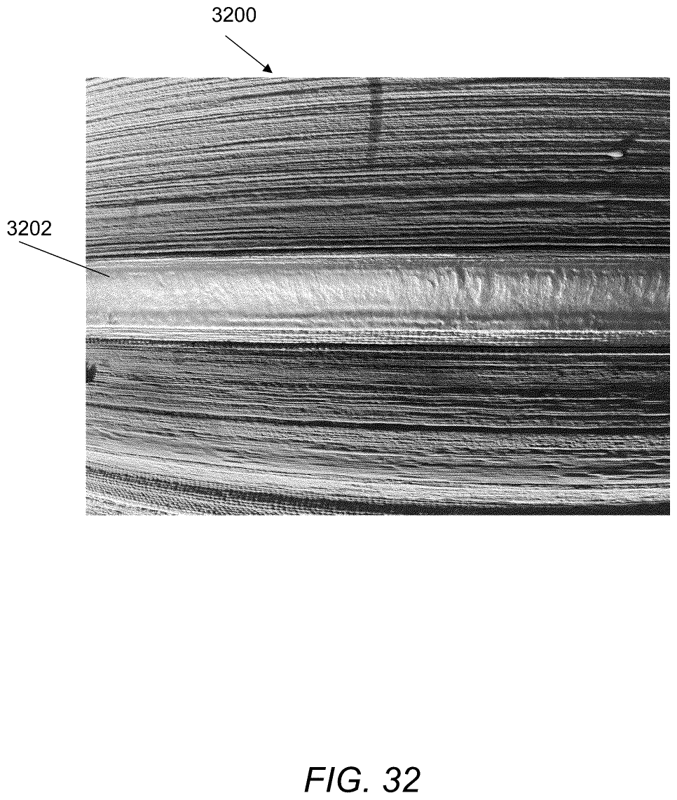

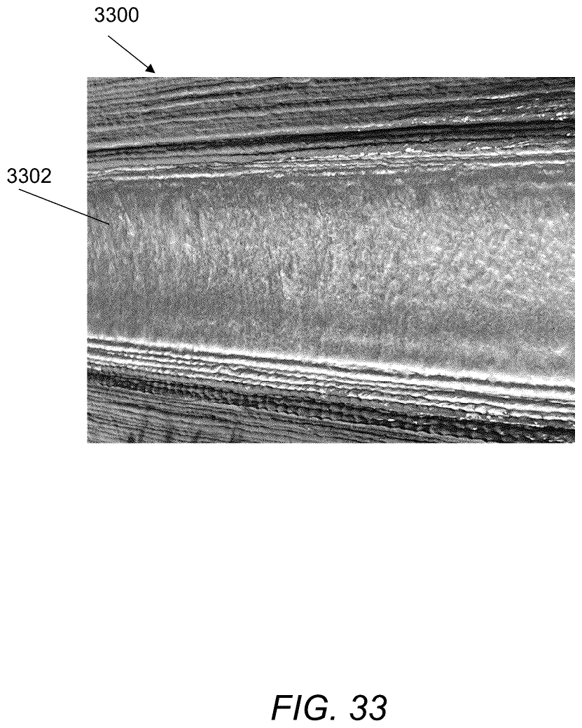

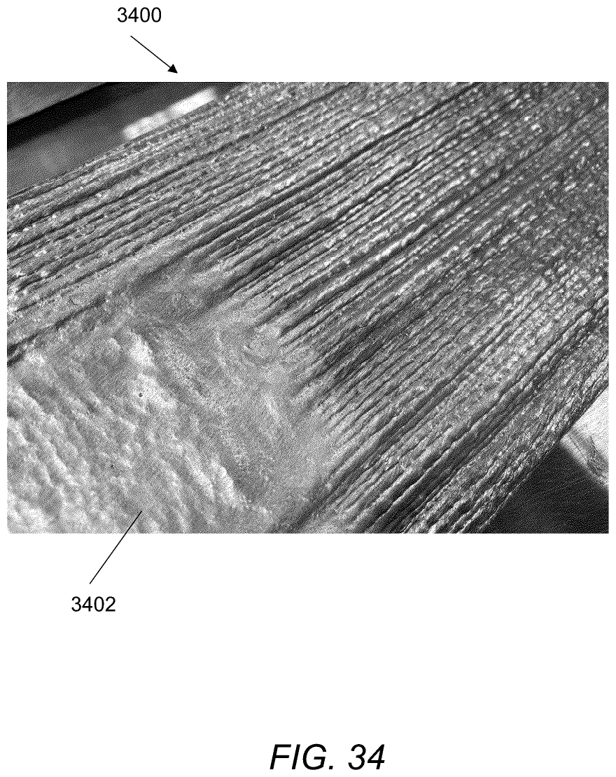

FIG. 32 depicts an example of a surface of an article that has been treated using plasma arc surface smoothing. An article 3200 can have a central region 3202 that has been treated using plasma arc surface smoothing. FIG. 33 depicts a closeup of a treatment area 3302 of the article 3300. FIG. 34 depicts a second example of a surface of an article that has been treated using plasma arc surface smoothing. An article 3400 can have a region 3402 that has been treated using plasma arc surface smoothing.

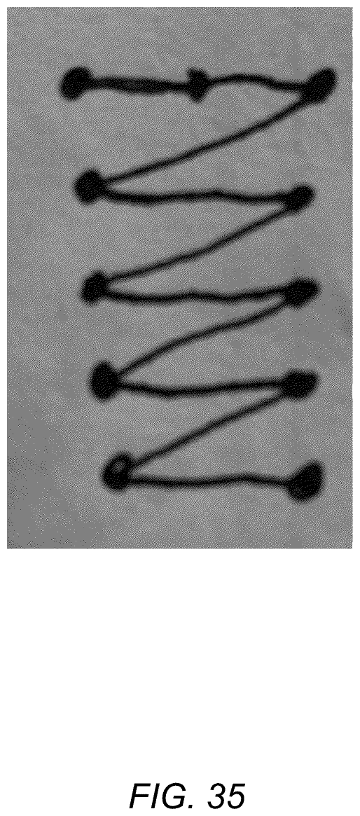

FIG. 35 depicts an example schematic of a weave pattern that can be used during plasma arc surface smoothing to define the path of a plasma arc assembly.

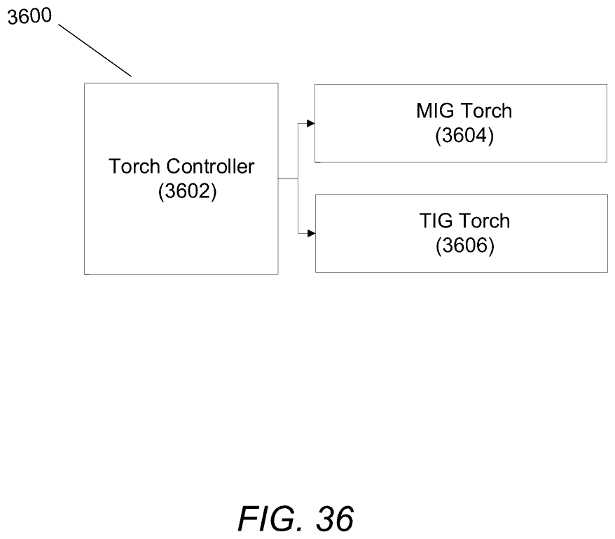

An example plasma torch system with a torch controller, a MIG torch and a TIG torch is conceptually illustrated in FIG. 36. The plasma torch system 3600 can include a torch controller 3602, a MIG torch (or MIG torches) 3604, and a TIG torch (or TIG torches) 3606. MIG torches can be configured to feed a wire and to provide MIG plasma arcs. A torch controller can include a processor, memory, and executable code. The torch controller 3602 can activate and/or deactivate the MIG torch 3604 and/or the TIG torch 3606. Torch controllers can include one or more computer systems.

In several embodiments, TIG torches can be configured to provide a TIG plasma arc capable of operating substantially simultaneously with MIG plasma arcs. Torch control systems can be configured to control the MIG torch and the TIG torch such that the plasma arc torch assembly is configured to perform plasma arc smoothing and additive manufacturing. These processes can be performed without needing to perform them simultaneously. During additive manufacturing of an article, a torch control system can control a MIG torch and a TIG torch such that the MIG plasma arc and the TIG plasma arc are simultaneously active, in accordance with some embodiments of the invention. In various embodiments, a torch control system can perform plasma arc surface smoothing by deactivating the MIG plasma arc and maintaining the MIG plasma arc inactive while the TIG plasma arc is active to provide heat for plasma arc surface smoothing on the article.

In various embodiments, the MIG torches 3604 and the TIG torches 3606 can be components of a dual plasma torch assembly. The torch controller 3602 can control the MIG torch components 3604 and the TIG torch components 3606 of the dual plasma torch assembly during additive printing and surface smoothing processes.

In some embodiments, the MIG torches 3604 and the TIG torches 3606 are separate tools. The torch controller 3602 can control the MIG torches 3604 during additive printing processes. The torch controller 3602 can control the TIG torches 3606 during surface smoothing processes. The MIG torches 3604 and the TIG torches can be attached and exchanged at the end effector of a robotic arm as a part of the print system.

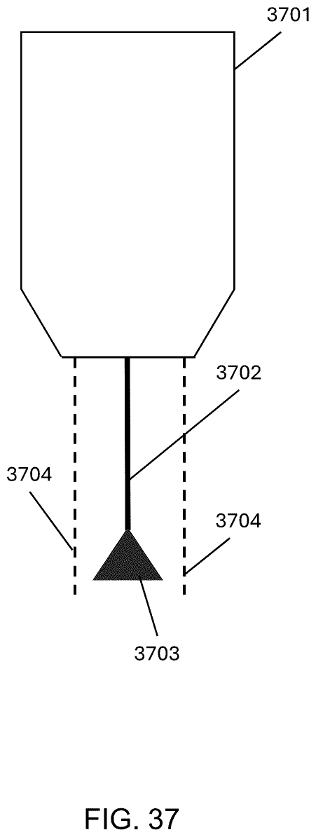

FIG. 37 illustrates a schematic of a working dual plasma torch assembly in accordance with an embodiment. The dual plasma torch assembly 3701 includes MIG torch components (not shown) and TIG torch components (not shown). During additive printing processes, the feed wire 3702 can be fed through at least one MIG torch component of the dual plasma torch assembly 3701. Electric energy applied at the feed wire 3702 can create an arc 3703. The arc 3703 can melt at least a portion of the feed wire 3702. The molten portion of the feed wire can be deposited on a support substrate or a previously deposited layer. The molten material can be deposited in a layer-by-layer fashion until forming a print part. In some embodiments, during additive printing processes, the TIG torch components can create plasma arcs 3704 that surrounds the arc 3703. The plasma arcs 3704 can be created via the electrode (such as tungsten electrodes) of the TIG torch components. The plasma arcs 3704 provide additional shielding for the feed wire 3702 and the arc 3704 during printing. In some embodiments, the plasma arcs 3704 may not be present during additive printing. During surface smoothing processes, the feed wire 3702 is turned off or retracted and the arc 3703 is not present for surface smoothing. The plasma arcs 3704 generated via the TIG torch components can smooth the surface and remove any undesired parasitic mass from the print surface. The plasma arcs 3704 can also shield the materials during surface smoothing.

While specific assemblies, components and/or systems for performing plasma arc surface smoothing are described above, any of a variety of assemblies, components and/or systems can be utilized for dual plasma surface smoothing as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are sometimes described in reference to a dual plasma torch, the techniques disclosed herein may be used in any type of suitable torch. The techniques disclosed herein may be used with any of the additive manufacturing assemblies, components, systems, methods and/or processes as described herein.

What is claimed is:

1. A method for smoothing a surface of an additively manufactured article, the method comprising:
printing, using an additive print head, a first layer of an additively manufactured article;
printing, using the additive print head, a second layer of the additively manufactured article, wherein the second layer is adjacent to the first layer, and wherein an edge of the first layer and an edge of the second layer define a surface of the additively manufactured article; and
smoothing, using the additive print head, the surface of the additively manufactured article after printing the first layer and printing the second layer.

2. The method of claim 1, wherein the printing the first layer includes directing, via the additive print head, a feed wire toward the first layer and further includes applying, via the additive print head, electrical energy through the feed wire to the additively manufactured article.

3. The method of claim 1, wherein the printing the first layer includes directing, via the additive print head, a feed wire toward the first layer and further includes applying, via the additive print head, electrical energy through an electrode separate from the feed wire to the additively manufactured article.

4. The method of claim 1, wherein the smoothing the surface includes applying, via the additive print head, electrical energy through an electrode separate from a feed wire to the additively manufactured article.

5. The method of claim 2, wherein the smoothing the surface includes applying, via the additive print head, electrical energy through an electrode separate from the feed wire to the additively manufactured article.

6. The method of claim 3, wherein the smoothing the surface includes applying, via the additive print head, electrical energy through an electrode separate from the feed wire to the additively manufactured article.

7. The method of claim 1, wherein the printing the first layer includes directing, via the additive print head, a feed wire toward the first layer and further includes applying an electrical arc to melt the feed wire to form the first layer of the additively manufactured article.

8. The method of claim 1, wherein the printing the first layer includes directing, via the additive print head, a feed wire toward the first layer and further includes applying, via the additive print head, electrical energy through an electrode separate from the feed wire to a gas to form a plasma arc to shield the additively manufactured article.

9. The method of claim 1, wherein the smoothing the surface includes applying, via the additive print head, electrical energy through an electrode separate from a feed wire to a gas to form a plasma arc; wherein the plasma arc smooths the surface of the additively manufactured article.

10. The method of claim 7, wherein the smoothing the surface includes applying, via the additive print head, electrical energy through an electrode separate from the feed wire to a gas to form a plasma arc; wherein the plasma arc smooths the surface of the additively manufactured article.

11. The method of claim 8, wherein the smoothing the surface includes applying, via the additive print head, electrical energy through an electrode separate from the feed wire to a gas to form a plasma arc; wherein the plasma arc smooths the surface of the additively manufactured article.

12. The method of claim 1, wherein the printing the first layer includes using a MIG component of the additive print head.

13. The method of claim 1, wherein the printing the first layer includes using a TIG component of the additive print head.

14. The method of claim 1, wherein the smoothing the surface includes using a TIG component of the additive print head.

15. The method of claim 12, wherein the smoothing the surface includes using a TIG component of the additive print head.

16. The method of claim 13, wherein the smoothing the surface includes using a TIG component of the additive print head.

17. The method of claim 1, wherein the additive print head includes at least one exit for surface smoothing plasma, and wherein smoothing the surface includes directing, via the additive print head, the surface smoothing plasma toward the surface of the additively manufactured article.

18. The method of claim 1, wherein the smoothing the surface includes moving the additive print head above the first layer and the second layer in a weave pattern.

19. The method of claim 1, wherein the smoothing the surface reduces a parasitic mass of the additively manufactured article.

20. The method of claim 1, wherein the additive print head comprises a dual plasma torch.

21. A system for smoothing a surface of an additively manufactured article, the system comprising:
at least one processing unit; and
at least one memory coupled to the at least one processing unit and storing instructions for execution by the at least one processing unit, the instructions when executed by the at least one processing unit cause the system to perform acts comprising:
printing, using an additive print head, a first layer of an additively manufactured article;
printing, using the additive print head, a second layer of the additively manufactured article, wherein the second layer is adjacent to the first layer, and wherein an edge of the first layer and an edge of the second layer define a surface of the additively manufactured article; and
smoothing, using the additive print head, the surface of the additively manufactured article after printing the first layer and printing the second layer.

22. A system for smoothing a surface of an additively manufactured article, the system comprising:
an additive print head;
at least one processing unit; and
at least one memory coupled to the at least one processing unit and storing instructions for execution by the at least one processing unit, the instructions when executed by the at least one processing unit cause the system to perform acts comprising:
printing, using the additive print head, a first layer of an additively manufactured article;
printing, using the additive print head, a second layer of the additively manufactured article, wherein the second layer is adjacent to the first layer, and wherein an edge of the first layer and an edge of the second layer define a surface of the additively manufactured article; and
smoothing, using the additive print head, the surface of the additively manufactured article after printing the first layer and printing the second layer.
